(19) United States
(12) Patent Application Publication
(10) Pub. No.: US 2026/0316367 A1
(43) Pub. Date: Oct. 15, 2026

(54) MATERIAL SPLITTERS, NOZZLES, AND HOLLOW SLEEVES FOR NOZZLE ASSEMBLIES AND RELATED DEVICES, SYSTEMS, AND METHODS

(71) Applicant: US Synthetic Corporation, Orem, UT (US)

(72) Inventors: Rodrigo Guerrero, Woodland Hills, UT (US); Harris Taylor, Lehi, UT (US)

(21) Appl. No.: 19/178,600

(22) Filed: Apr. 14, 2025

(51) Int. Cl. B29C 64/209; B29C 64/118; B33Y 30/00

(52) U.S. Cl. CPC B29C 64/209; B29C 64/118; B33Y 30/00

(57) ABSTRACT

One or more of a material splitter comprising a superhard material, a nozzle comprising a superhard material, or a hollow sleeve comprising a superhard material may be utilized in a nozzle assembly for three-dimensional printing. The nozzle splitter may include an annular portion having an outer surface sized and configured for insertion into a nozzle body of a three-dimensional printer. A central portion may be located at least partially within the annular portion, and a plurality of ribs may extend laterally between and connect the annular portion to the central portion. A plurality of passageways may extend through the material splitter, the passageways defined by the annular portion, the central portion, and the plurality of ribs.

### TECHNICAL FIELD

This application relates to nozzle assemblies and material splitters, nozzles, and hollow sleeves for nozzle assemblies for 3D printing, and related devices, systems, and methods.

### BACKGROUND

Three-dimensional (“3D”) printing is a method that includes dispensing a first layer of material onto a platform from a nozzle. Additional layers of material may be dispensed from the nozzle onto the first and subsequent layers until a three-dimensional object is formed. However, several issues exist with conventional nozzle assemblies and components thereof, such as unsatisfactory flow rate of the material being dispensed, slow printing rates, poor print quality, stringing, and excessive wear. Thus, new and improved nozzle assemblies and components for nozzle assemblies are desirable.

### SUMMARY

In some aspects, the techniques described herein relate to nozzle assemblies and material splitters, nozzles, and hollow sleeves for nozzle assemblies for 3D printing, and related devices systems and methods.

In some aspects, the techniques described herein relate to a material splitter including: an annular portion having an outer surface sized and configured for insertion into and to abut a bore of a nozzle body of a three-dimensional printer; a central portion located at least partially within the annular portion; a plurality of ribs extending laterally between and connecting the annular portion to the central portion; a plurality of passageways extending through the material splitter defined by the annular portion, the central portion, and the plurality of ribs; and wherein the material splitter is a monolithic superhard material.

In some aspects, the techniques described herein relate to a material splitter, further including a spike extending longitudinally from an upper end of the central portion, the spike having a pointed end.

In some aspects, the techniques described herein relate to a material splitter, wherein the material splitter is a monolithic diamond structure.

In some aspects, the techniques described herein relate to a material splitter, wherein the material splitter has laser-ablated surfaces.

In some aspects, the techniques described herein relate to a material splitter, wherein each of the plurality of passageways has an elongated arcuate cross-sectional shape with rounded ends.

In some aspects, the techniques described herein relate to a material splitter, wherein each of the plurality of passageways have an inlet opening that is larger than an outlet opening.

In some aspects, the techniques described herein relate to a material splitter, wherein each of the plurality of passageways has a continuous taper from the inlet opening to the outlet opening.

In some aspects, the techniques described herein relate to a material splitter, further including a radiused edge at the inlet opening of each of the plurality of passageways.

In some aspects, the techniques described herein relate to a material splitter, further including a radiused edge at the outlet opening of each of the plurality of passageways.

In some aspects, the techniques described herein relate to a material splitter, wherein the material splitter is configured to increase the maximum operational flow rate of a three-dimensional printer by at least about 30%.

In some aspects, the techniques described herein relate to a nozzle assembly including: a base configured to be part of a three-dimensional printer, the base defining a recess; and a material splitter positioned within the recess, the material splitter including: an annular portion having an outer surface sized to abut a bore of the recess; a central portion located at least partially within the annular portion; a plurality of ribs extending laterally between and connecting the annular portion to the central portion; and a plurality of passageways extending through the material splitter defined by the annular portion, the central portion, and at least one rib; and wherein the material splitter is a monolithic diamond structure.

In some aspects, the techniques described herein relate to a nozzle assembly, further including a hollow sleeve press-fit into the recess and securing the material splitter within the recess.

In some aspects, the techniques described herein relate to a nozzle assembly, further including a nozzle positioned within the recess, and the hollow sleeve securing the material splitter and the nozzle within the recess.

In some aspects, the techniques described herein relate to a nozzle assembly, wherein the hollow sleeve is a monolithic diamond structure.

In some aspects, the techniques described herein relate to a nozzle assembly, further including at least a second material splitter positioned within the recess.

In some aspects, the techniques described herein relate to a nozzle assembly, further including a nozzle and wherein the material splitter is secured within the recess by the nozzle.

In some aspects, the techniques described herein relate to a nozzle assembly, further including a nozzle having a passageway extending through the nozzle with a material inlet and a material outlet, the passageway including a constriction between the material inlet and the material outlet, the constriction having a diameter smaller than the material inlet and the material outlet, and wherein surfaces defining the passageway are oriented at an angle that is less than about 45 degrees relative to a longitudinal axis of the nozzle.

In some aspects, the techniques described herein relate to a nozzle assembly, wherein the nozzle further includes a substantially planar surface at a tip surrounding the material outlet of the bore, the substantially planar surface having a diameter that is at least about 2 times the diameter of the material outlet of the bore.

In some aspects, the techniques described herein relate to a method of manufacturing a material splitter for a nozzle assembly for three-dimensional printing, the method including: forming a precursor structure including a superhard material; and removing a portion of the superhard material from the precursor structure to form a material splitter from the superhard material.

In some aspects, the techniques described herein relate to a method, wherein removing the portion of the superhard material from the precursor structure includes laser ablation of the portion of the superhard material.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a cross-sectional view of a nozzle assembly including a nozzle body, a nozzle, a material splitter, and a hollow sleeve, according to an embodiment of the present disclosure.

FIG. 2A is a cross-sectional view of the nozzle of the nozzle assembly of FIG. 1.

FIG. 2B is an isometric view of the nozzle of FIG. 2A.

FIG. 3A is a cross-sectional view of the material splitter of the nozzle assembly of FIG. 1, which includes four passageways according to an embodiment of the present disclosure.

FIG. 3B is an isometric view of the material splitter of FIG. 3A.

FIG. 3C is a bottom view of the material splitter of FIG. 3A.

FIG. 3D is a top view of the material splitter of FIG. 3A.

FIG. 4A is a cross-sectional view of a material splitter, which may be utilized in a nozzle assembly such as the nozzle assembly of FIG. 1, which includes two passageways according to an embodiment of the present disclosure.

FIG. 4B is an isometric view of the material splitter of FIG. 4A.

FIG. 4C is a bottom view of the material splitter of FIG. 4A.

FIG. 4D is a top view of the material splitter of FIG. 4A.

FIG. 5A is an isometric top view of a material splitter, which may be utilized in a nozzle assembly such as the nozzle assembly of FIG. 1, which includes three passageways according to an embodiment of the present disclosure.

FIG. 5B is an isometric bottom view of the material splitter of FIG. 5A.

FIG. 6A is an isometric top view of a material splitter, which may be utilized in a nozzle assembly such as the nozzle assembly of FIG. 1, which includes three passageways in a spiral configuration according to an embodiment of the present disclosure.

FIG. 6B is an isometric bottom view of the material splitter of FIG. 6A.

FIG. 7A is an isometric top view of a material splitter, which may be utilized in a nozzle assembly such as the nozzle assembly of FIG. 1, which includes four passageways divided by ribs that are relatively narrow according to an embodiment of the present disclosure.

FIG. 7B is an isometric bottom view of the material splitter of FIG. 7A.

FIG. 8A is an isometric top view of a material splitter, which may be utilized in a nozzle assembly such as the nozzle assembly of FIG. 1, which includes four passageways divided by ribs that are relatively narrow and including a relatively small spike according to an embodiment of the present disclosure.

FIG. 8B is an isometric bottom view of the material splitter of FIG. 8A.

FIG. 9A is an isometric top view of a material splitter, which may be utilized in a nozzle assembly such as the nozzle assembly of FIG. 1, which includes eight passageways divided by ribs that are relatively narrow according to an embodiment of the present disclosure.

FIG. 9B is an isometric bottom view of the material splitter of FIG. 9A.

FIG. 10 illustrates an isometric view of the hollow sleeve of the nozzle assembly of FIG. 1, according to an embodiment of the present disclosure.

FIG. 11 is a cross-sectional view of a nozzle assembly including a plurality of material splitters, according to an embodiment of the present disclosure.

FIG. 12 is a cross-sectional view of a nozzle assembly with a nozzle body having a material splitter and hollow sleeve located in a first recess and a nozzle located in a second recess, according to an embodiment of the present disclosure.

FIG. 13 is a cross-sectional view of a nozzle assembly with a nozzle retaining a material splitter within a recess of a nozzle body, according to an embodiment of the present disclosure.

FIG. 14 is a schematic illustration of an embodiment of a method for fabricating one or more material splitters, nozzles, and/or hollow sleeves comprising a superhard material, according to embodiments of the present disclosure.

### DETAILED DESCRIPTION

As used herein, relational terms, such as “first,” “second,” “top,” “bottom,” etc., are generally used for clarity and convenience in understanding the disclosure and accompanying drawings and do not connote or depend on any specific preference, orientation, or order, except where the context clearly indicates otherwise.

As used herein, the term “and/or” means and includes any one of the associated listed items or any and all combinations of one or more of the associated listed items.

The term “superabrasive” or the term “superhard,” as used herein, refers to any material having a hardness that is at least equal to a hardness of tungsten carbide. For example, a superhard article may represent an article of manufacture, at least a portion of which may exhibit a hardness that is equal to or greater than the hardness of tungsten carbide.

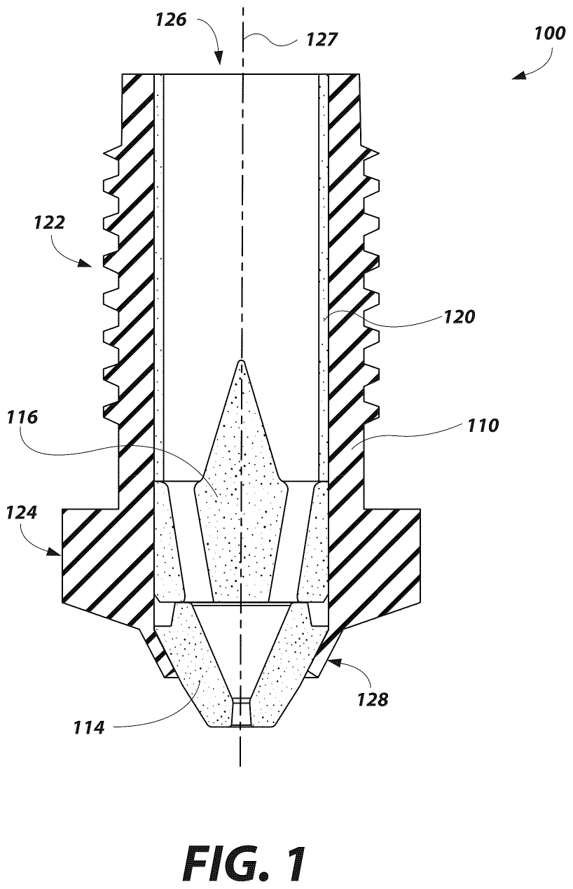

FIG. 1 is a cross-sectional view of a nozzle assembly 100 including a nozzle body 110, a nozzle 114, a material splitter 116, and a hollow sleeve 120, according to an embodiment of the present disclosure. The phrase “material splitter” means a body having a geometry facilitating 3D printing filament passing into a plurality of passageways formed in (or defined by) the body. For example, a material splitter may have a protrusion which, when encountered by a 3D printing filament, changes the shape of the 3D printing filament to facilitate such 3D printing filament passing into (and through) a plurality of passageways extending through the body.

The nozzle body 110 may be configured to attach to one or more components of a 3D printer, such as, for example, a material heater and/or a material feeder, so that the nozzle assembly 100 may be utilized as a part of the 3D printer to dispense printing material for additive manufacturing. Accordingly, the nozzle body 110 may include features for attachment to a 3D printer, such as a threaded portion 122 for mating with a threaded receptacle and flats 124 to facilitate turning the nozzle body 110 with a wrench. In additional embodiments, the nozzle body 110 may include attachment structures in addition to, or instead of, the threaded portion 122, such as a dimensioned portion sized and configured for press-fitting, brazing, soldering, swaging, and/or adhesive attachment to a 3D printer. In further embodiments, the nozzle body 110 may include a quick-connect coupler.

The nozzle body 110 may include a recess 126 extending longitudinally into the nozzle body 110 along a central longitudinal axis 127 the recess may be sized to receive the material splitter 116, the nozzle 114, and the hollow sleeve 120. Additionally, the nozzle body 110 may include a feature, such as a wall 128 at an end of the recess 126 which may extend over a portion of the nozzle 114 to maintain the nozzle 114 within the recess 126 of the nozzle body 110 and/or provide a seal between the nozzle 114 and the nozzle body 110.

The nozzle 114 may have an outer diameter sized to fit within a bore (e.g., a cylindrical opening) of the recess 126, such that the nozzle 114 may be positioned within the recess 126 of the nozzle body 110. Similarly, the material splitter 116 may have an outer diameter sized to fit within the bore of the recess 126 and that may abut the nozzle body 110 when inserted into the bore of the recess 126.

The hollow sleeve 120 may be sized with an outer diameter that is similar in size to the bore of the recess 126 of the nozzle body 110 so that the hollow sleeve 120 may be positioned (e.g., press fit) into the recess 126 until a lower surface of the material splitter 116 contacts an upper surface of the nozzle 114, and a lower surface of the hollow sleeve 120 contacts an upper surface of the material splitter 116. In one embodiment, after being press fit into the recess 126, mechanical interference between the hollow sleeve 120 and the nozzle body 110 may inhibit the movement of the hollow sleeve 120 relative to the nozzle body 110 and the hollow sleeve 120 may secure the material splitter 116 and the nozzle 114 within the recess 126 of the nozzle body 110. In some embodiments, the hollow sleeve 120 may be attached (e.g., press fit, brazed, soldered, swaged, attached with one or more fastener, and/or adhesively adhered to the nozzle body 110) to the recess 126 and/or nozzle body 110. Optionally, in some embodiments, the nozzle 114 and/or the material splitter 116 may be sized to be press fit into the recess 126 or swaged within the recess 126.

In additional embodiments, the hollow sleeve 120, the material splitter 116, and/or the nozzle 114 may be brazed, soldered, swaged, and/or adhesively adhered to the nozzle body 110, which may inhibit the movement of the hollow sleeve 120, the material splitter 116, and/or the nozzle 114 relative to the nozzle body 110 and may improve the heat transfer between nozzle body 110 and the hollow sleeve 120, the material splitter 116, and/or the nozzle 114.

In some embodiments, the nozzle body 110 may comprise one or more of copper, brass, bronze, aluminum, iron, steel, titanium, and/or another suitable metal or metal alloy, and may be manufactured using traditional methods, such as casting, forging, stamping, forming, and/or machining.

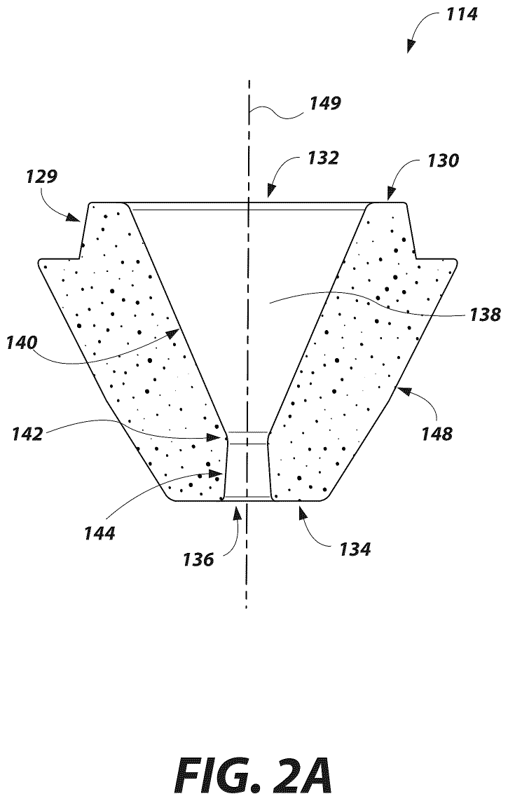

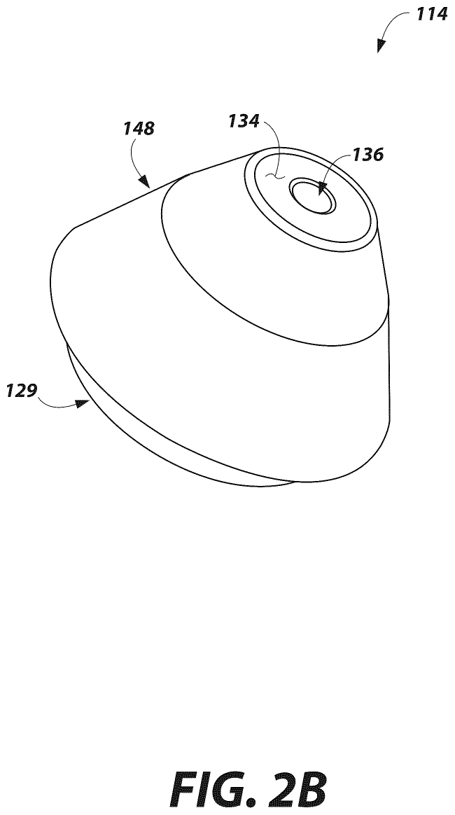

FIGS. 2A-2B illustrate the nozzle 114 of the nozzle assembly 100 of FIG. 1. FIG. 2A is a cross-sectional view of the nozzle 114, and FIG. 2B is an isometric view of the nozzle 114.

The nozzle 114 may include a seat 129 with a substantially planar surface 130 for sealing the nozzle 114 against an adjacent structure, such as the material splitter 116, the substantially planar surface 130 surrounding an inlet opening 132. The nozzle 114 may additionally include a tip with a substantially planar surface 134 surrounding an outlet opening 136. Passageway 138 may extend longitudinally through the nozzle 114 extending from the inlet opening 132 to the outlet opening 136. An upper portion 140 of the passageway 138 may have a funnel-like shape (e.g., a frustoconical shape) narrowing from the inlet opening 132 to a constriction 142. A lower portion 144 of the passageway 138 may have a substantially cylindrical shape or a generally funnel-like shape (e.g., a frustoconical shape, concave shape, or bowl-like shape) widening from the constriction 142 to the outlet opening 136. The nozzle 114 may additionally include a tapered outer surface 148 extending from the substantially planar surface 134 to a shoulder adjacent the seat 129, and an edge of the nozzle 114 may be radiused or chamfered where the tapered outer surface 148 and the substantially planar surface 134 meet.

In some embodiments, the substantially planar surface 134 may have a diameter that is significantly larger than a diameter of the outlet opening 136, which may provide a significant amount of planar surface adjacent to and surrounding the outlet opening 136. For example, the substantially planar surface 134 may have a diameter that is: greater than about 2 times the diameter of the outlet opening 136, greater than about 2.5 times the diameter of the outlet opening 136, and/or greater than about 3 times the diameter of the outlet opening 136. Accordingly, the substantially planar surface 134 may provide a constraint between molten printing material dispensed from the nozzle 114 through the outlet opening 136 and underlying printed material as the nozzle 114 is moved in a horizontal plane, substantially parallel to the substantially planar surface 134 as the printing material solidifies. This may improve adhesion of the printing material dispensed from the nozzle 114 to underlying printed material.

In some embodiments, the constriction 142 may be located a substantial distance from the outlet opening 136. For example, the constriction 142 may be located a distance from the outlet opening 136 of: at least about 0.25 times the diameter of the outlet opening 136, at least about 0.5 times the diameter of the outlet opening 136, at least about 0.75 times the diameter of the outlet opening 136, at least about 1 times the diameter of the outlet opening 136, at least about 1.25 times the diameter of the outlet opening 136, and/or at least about 1.5 times the diameter of the outlet opening 136.

In some embodiments, the constriction 142 and the outlet opening 136 may be substantially the same size, or similarly sized with the diameter of the outlet opening 136 being slightly larger than a diameter of the outlet opening 136. For example, the diameter of the outlet opening 136 may be: less than about 50% larger than the diameter of the constriction 142, less than about 30% larger than the diameter of the constriction 142, less than about 20% larger than the diameter of the constriction 142, less than about 10% larger than the diameter of the constriction 142, less than about 5% larger than the diameter of the constriction 142, and/or substantially the same size as the diameter of the constriction 142. Accordingly, a significant surface area of the printing material flowing through the lower portion 144 of the nozzle 114 may be in contact with the nozzle 114 relative to the volume of printing material flowing through the lower portion 144 of the nozzle 114 over a significant distance (e.g., between the constriction 142 and the outlet opening 136).

Walls defining the passageway 138 may be configured so that they do not deviate from longitudinal axis 127 of the nozzle 114 by a large amount. For example, the walls defining the passageway 138 may be oriented at a respective angle that is: less than about 45 degrees relative to the longitudinal axis 149 of the nozzle 114, less than about 40 degrees relative to the longitudinal axis 149 of the nozzle 114, less than about 35 degrees relative to the longitudinal axis 149 of the nozzle 114, less than about 30 degrees relative to the longitudinal axis 149 of the nozzle 114, and/or less than about 25 degrees relative to the longitudinal axis 149 of the nozzle 114. These features may improve printing material flow through the nozzle 114 and may reduce and/or eliminate stringing relative to other nozzle designs, such as nozzles having a drastic change in passageway diameter (e.g., a shelf-like transition) near a printing material outlet.

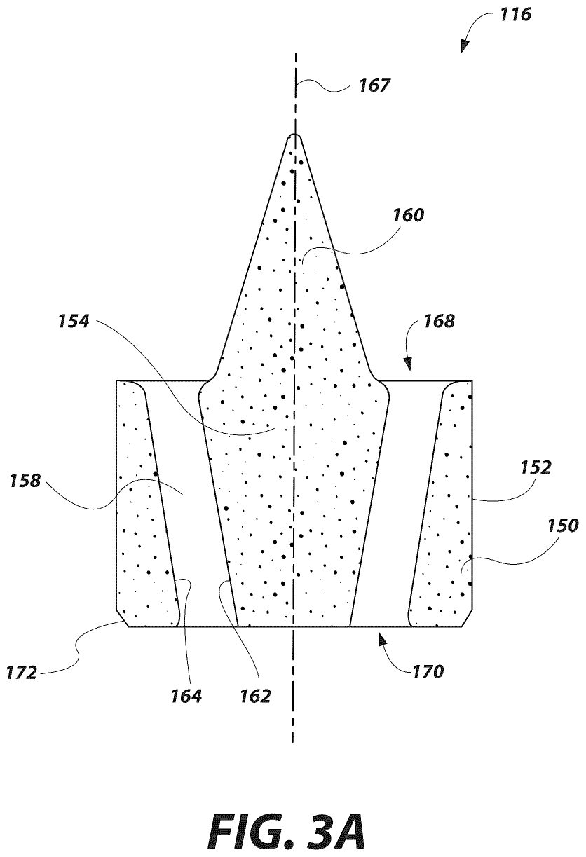

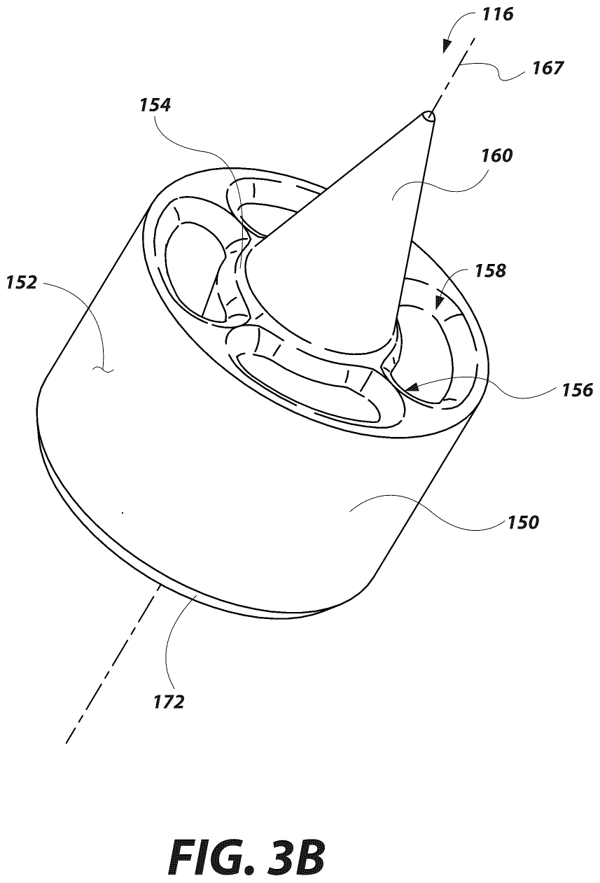

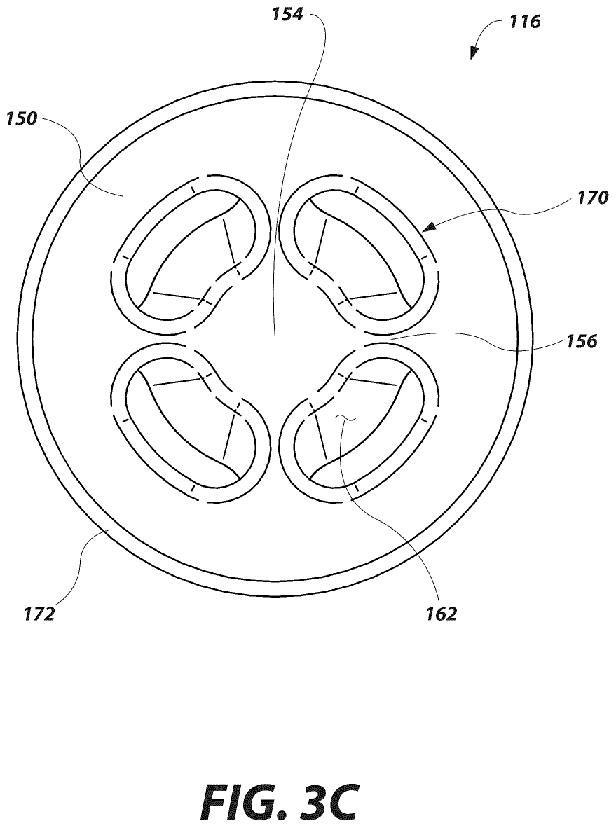

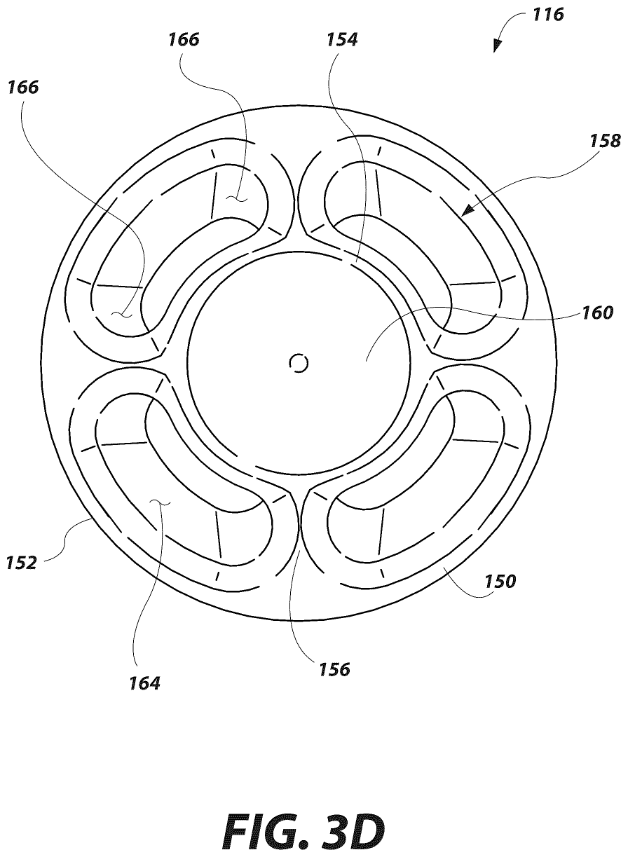

FIGS. 3A-3D illustrate the material splitter 116 of the nozzle assembly 100 of FIG. 1, which includes four passageways 158 according to an embodiment of the present disclosure. FIG. 3A is a cross-sectional view of the material splitter 116, FIG. 3B is an isometric view of the material splitter 116, FIG. 3C is a bottom view of the material splitter 116, and FIG. 3D is a top view of material splitter 116.

The material splitter 116 may include an annular portion 150 having an outer surface 152 sized and configured for insertion into and to abut an inner wall of a bore defined by the nozzle body 110 (see FIG. 1). A central portion 154 may be located at least partially within the annular portion 150 and a plurality of ribs 156 may extend laterally between and connect the annular portion 150 to the central portion 154. A plurality of passageways 158 may extend through the material splitter, each of the passageways 158 defined by the annular portion 150, the central portion 154, and the plurality of ribs 156.

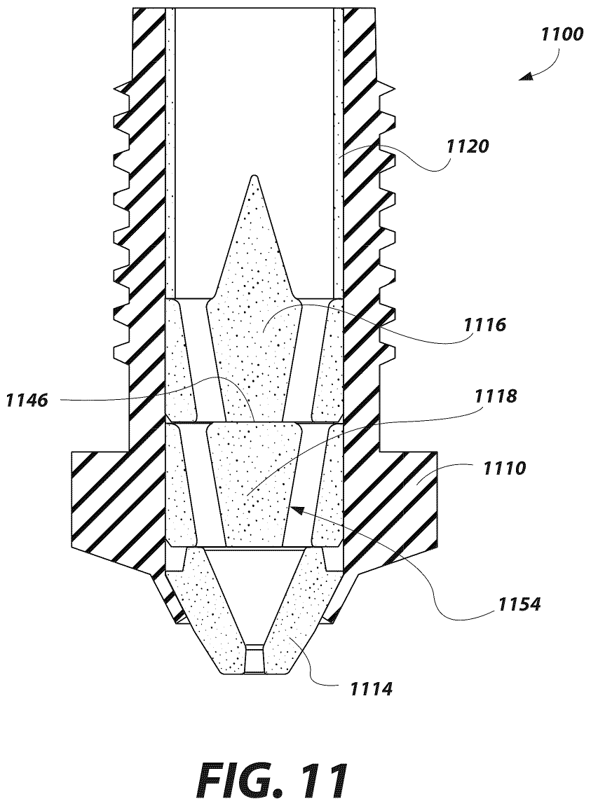

In some embodiments, the material splitter 116 may include a spike 160 extending longitudinally from an upper end of the central portion 154, which may assist in facilitating the flow of softened/liquified material, which may be provided in the form of a solid filament (e.g., that may not have fully liquified prior to contacting the material splitter 116). For example, spike 160 may have a shape that extends to a pointed end and/or at least one relatively sharp edge. For example, the spike 160 may have a conical shape, as shown in FIG. 3B, or another shape, such as a multifaceted pyramidal shape, a wedge shape, or some combination thereof. In further embodiments, such as embodiments wherein material splitters are used in a stacked configuration, as will be discussed in further detail herein with reference to FIG. 11, a material splitter may not include a spike.

The entirety of the material splitter 116, including the annular portion 150, the central portion 154, and the plurality of ribs 156 (and the spike 160 if included), may comprise a single material and may be a monolithic structure (e.g., may be formed by a monolithic superhard material). For example, the entirety of the material splitter 116 may be a monolithic diamond structure, such as a polycrystalline diamond (“PCD”) structure. For another example, the entirety of the material splitter 116 may be a polycrystalline cubic boron nitride (“PcBN”) structure.

Each of the passageways 158 may have an elongated arcuate cross-sectional shape with rounded ends. Each of the passageways 158 may be defined by a radially inner surface 162 defined by the central portion 154 of the material splitter 116, a radially outer surface 164 defined by the annular portion 150 of the material splitter 116, and two end surfaces 166 defined by the adjacent ribs 156 of the material splitter 116. The radially inner surface 162 may be shaped as a portion of a frustrum of a cone that is substantially coaxial to the longitudinal axis 167 of the material splitter 116 and having a first cone angle. The radially outer surface 164 may be shaped as a portion of a frustrum of a cone that is substantially coaxial to the longitudinal axis 167 of the material splitter 116 and having a second cone angle. Each of the two end surfaces 166 may be shaped as a portion of a frustrum of a cone or a portion of a cylinder and may provide a relatively smooth (e.g., rounded) transition between the radially inner surface 162 and the radially outer surface 164. Additionally, the first cone angle of the radially inner surface 162 may be smaller than the second cone angle of the radially outer surface 164.

Accordingly, an inlet opening 168 of each passageway 158 may be larger than an outlet opening 170 of each passageway 158 (e.g., the inlet opening 168 may have a larger cross-sectional area than the outlet opening 170). Additionally, each passageway 158 may extend radially inward from the inlet opening 168 to the outlet opening 170, and each of the passageways 158 may have a continuous taper from the inlet opening 168 to the outlet opening 170. In some embodiments, a cross-sectional area of each inlet opening 168 may be: greater than about 1.2 times larger than a cross-sectional area of each outlet opening 170, greater than about 1.3 times larger than a cross-sectional area of each outlet opening 170, greater than about 1.4 times larger than a cross-sectional area of each outlet opening 170, and/or greater than about 1.5 times larger than a cross-sectional area of each outlet opening 170. For example, the cross-sectional area of the inlet opening 168 may be about 0.0047 square inches (about 0.0303 square centimeters) and the cross-sectional area of the outlet opening 170 may be about 0.003 square inches (about 0.019 square centimeters).

An edge of the inlet opening 168 of each of the passageways 158 may be rounded or chamfered, for example, the inlet opening 168 may have a radiused edge at an inner diameter and/or an outer diameter. Similarly, an edge of the outlet opening 170 may be rounded or chamfered, for example, the outlet opening 170 may have a radiused edge at an inner diameter and/or an outer diameter. This may facilitate an efficient flow of printing material through the material splitter 116.

Additional edges of the material splitter 116 may also be rounded or chamfered. For example, a radially outer edge 172 of a lower end of the annular portion 150 may be a chamfered edge and/or a radiused edge. This may facilitate the insertion of the material splitter 116 into the recess 126 of the nozzle body 110.

The material splitter 116 in the nozzle assembly 100 may provide additional heat transfer to printing material flowing through the nozzle assembly 100 compared to nozzle assemblies that do not include such a material splitter and improved liquification of the printing material within the nozzle assembly 100, which may facilitate a relatively high flowrate of printing material through the nozzle assembly 100.

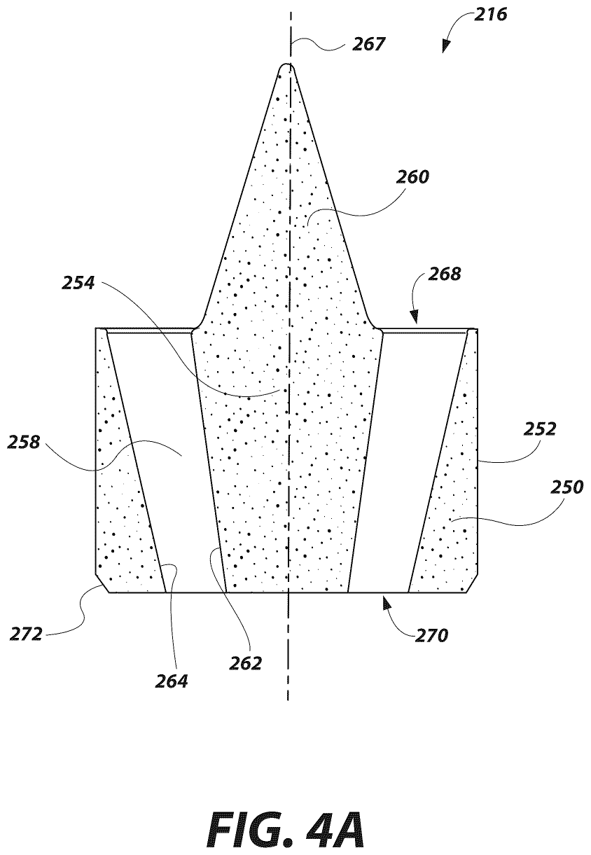

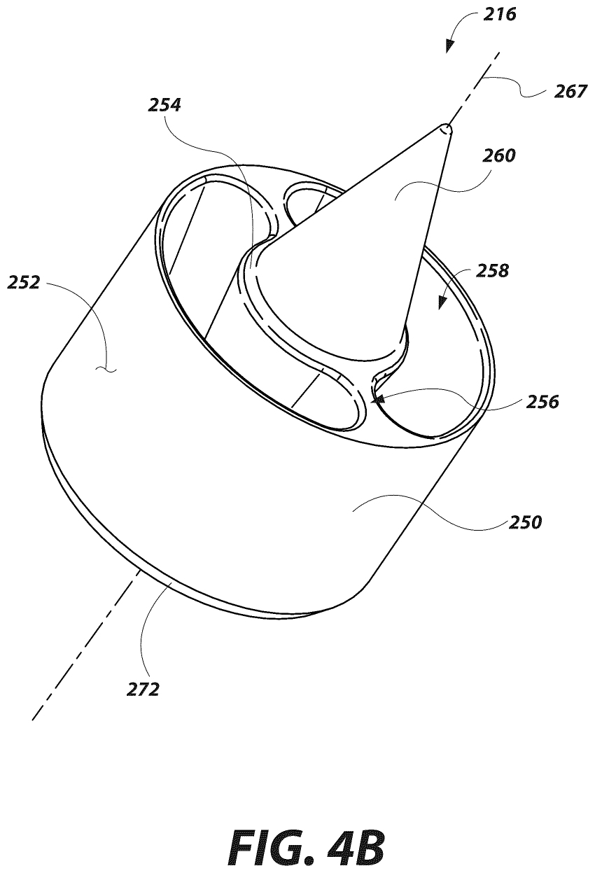

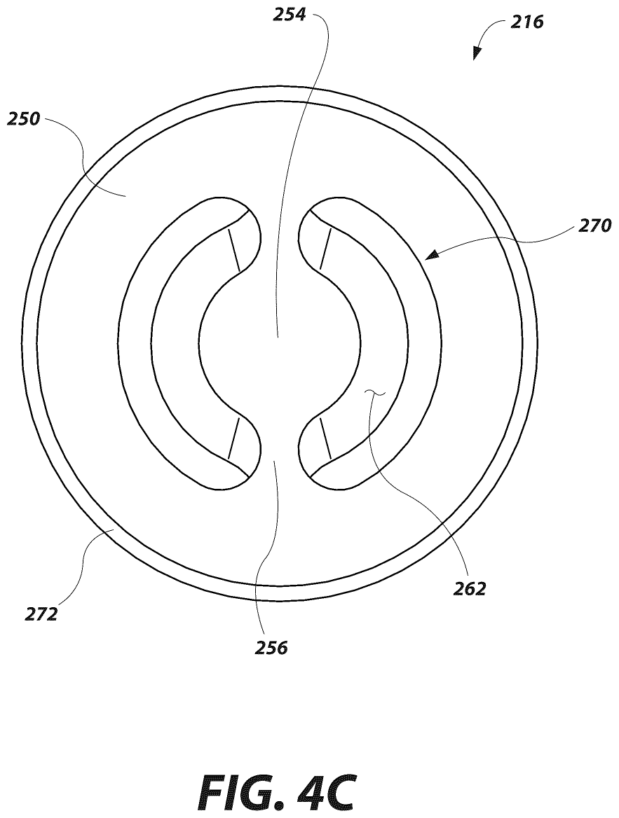

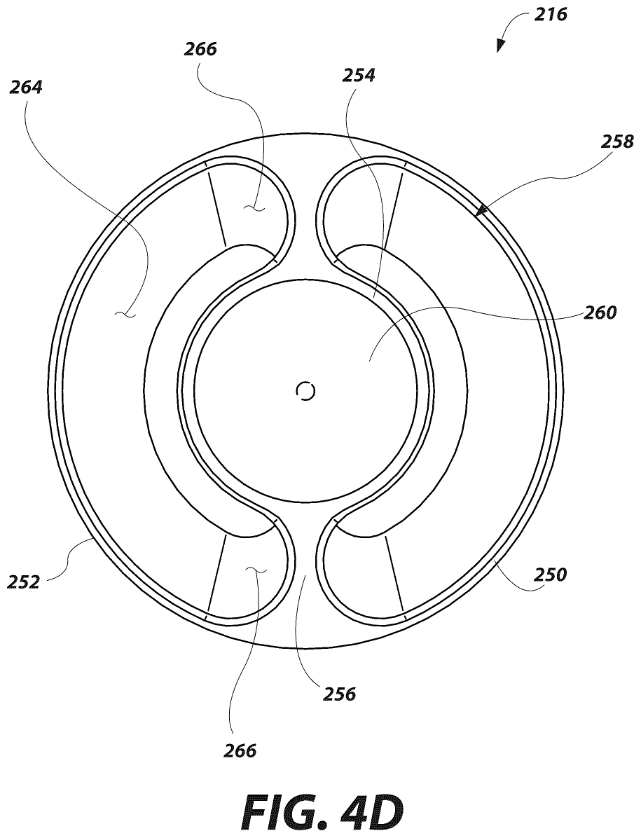

FIGS. 4A-4D illustrates a material splitter 216, which may be utilized in a nozzle assembly such as the nozzle assembly 100 of FIG. 1, which includes two passageways 258 according to an embodiment of the present disclosure. FIG. 4A is a cross-sectional view of the material splitter 216, FIG. 4B is an isometric view of the material splitter 216, FIG. 4C is a bottom view of the material splitter 216, and FIG. 4D is a top view of material splitter 216.

Although the material splitter 216 is shown with two passageways 258 and the material splitter 116 is shown with four passageways 158, material splitters according to embodiments of the present disclosure may include three passageways and/or may include more than four passageways.

Similar to the material splitter 116, the material splitter 216 may include an annular portion 250 having an outer surface 252 sized and configured for insertion into and to abut a bore of the nozzle body 110. A central portion 254 may be located at least partially within the annular portion 250 and a plurality of ribs 256 may extend laterally between and connect the annular portion 250 to the central portion 254. The plurality of passageways 258 may extend through the material splitter 216, each of the passageways 258 defined by the annular portion 250, the central portion 254, and the plurality of ribs 256. In some embodiments, the material splitter 216 may include a spike 260 extending longitudinally from an upper end of the central portion 254.

In some embodiments the entirety of the material splitter 216 may be a monolithic diamond structure, such as a polycrystalline diamond (“PCD”) structure. In further embodiments, the entirety of the material splitter 216 may be a polycrystalline cubic boron nitride (“PcBN”) structure.

Each of the passageways 258 may have an elongated arcuate cross-sectional shape with rounded ends. Each of the passageways 258 may be defined by a radially inner surface 262 defined by the central portion 254 of the material splitter 216, a radially outer surface 264 defined by the annular portion 250 of the material splitter 216, and two end surfaces 266 defined by the adjacent ribs 256 of the material splitter 216. The radially inner surface 262 may be shaped as a portion of a frustrum of a cone that is substantially coaxial to the longitudinal axis 267 of the material splitter 216 and having a first cone angle. The radially outer surface 264 may be shaped as a portion of a frustrum of a cone that is substantially coaxial to the longitudinal axis 267 of the material splitter 216 and having a second cone angle. Each of the two end surfaces 266 may be shaped as a portion of a frustrum of a cone or a portion of a cylinder and may provide a relatively smooth (e.g., rounded) transition between the radially inner surface 262 and the radially outer surface 264. Additionally, the first cone angle of the radially inner surface 262 may be smaller than the second cone angle of the radially outer surface 264.

Accordingly, an inlet opening 268 of each passageway 258 may be larger than an outlet opening 270 of each passageway 258 (e.g., the inlet opening 268 may have a larger cross-sectional area than the outlet opening 270). Additionally, each passageway 258 may extend radially inward from the inlet opening 268 to the outlet opening 270, and each of the passageways 258 may have a continuous taper from the inlet opening 268 to the outlet opening 270. In some embodiments, a cross-sectional area of each inlet opening 268 may be: greater than about 1.75 times larger than a cross-sectional area of each outlet opening 270, greater than about 2 times larger than a cross-sectional area of each outlet opening 270, greater than about 2.25 times larger than a cross-sectional area of each outlet opening 270, and/or greater than about 2.4 times larger than a cross-sectional area of each outlet opening 270. For example, the cross-sectional area of the inlet opening 268 may be about 0.017 square inches (about 0.110 square centimeters) and the cross-sectional area of the outlet opening 270 may be about 0.007 square inches (about 0.045 square centimeters).

An edge of the inlet opening 268 and/or the outlet opening 270 of each of the passageways 258 may be radiused or chamfered. Additionally, a radially outer edge 272 of a lower end of the annular portion 250 may be a chamfered edge and/or a radiused edge.

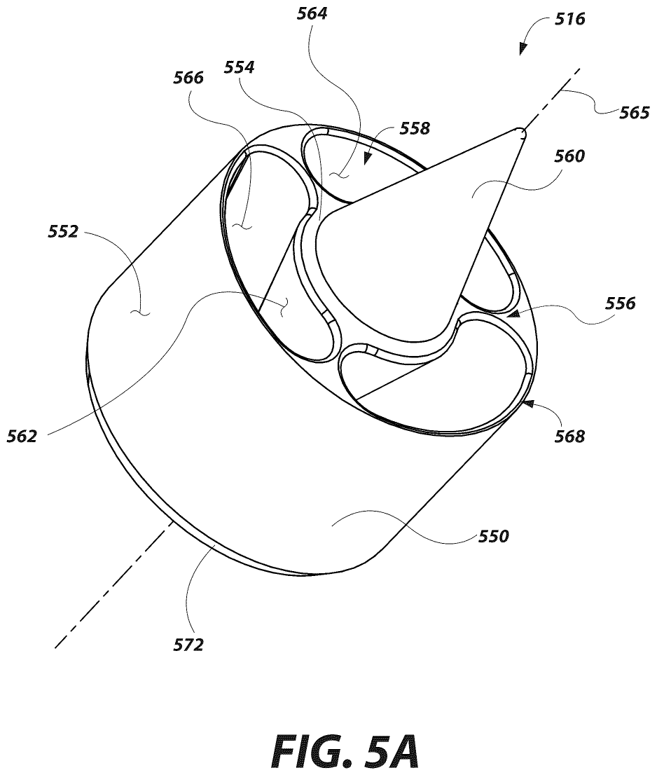

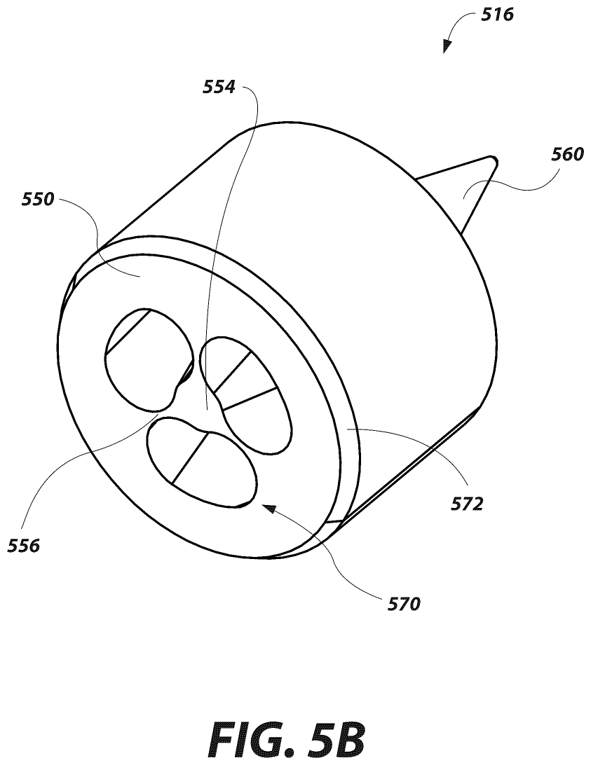

FIGS. 5A-5B illustrate a material splitter 516, which may be utilized in a nozzle assembly such as the nozzle assembly 100 of FIG. 1, which includes three passageways 558 according to an embodiment of the present disclosure. FIG. 5A is a top isometric view of the material splitter 516, and FIG. 5B is a bottom isometric view of the material splitter 516.

Although the material splitter 516 is shown with three passageways 558, the material splitter 216 is shown with two passageways 258, and the material splitter 116 is shown with four passageways 158, material splitters according to embodiments of the present disclosure may include may include more than four passageways.

Similar to the material splitter 116, the material splitter 516 may include an annular portion 550 having an outer surface 552 sized and configured for insertion into and to abut a bore of the nozzle body 110. A central portion 554 may be located at least partially within the annular portion 550 and a plurality of ribs 556 may extend laterally between and connect the annular portion 550 to the central portion 554. The plurality of passageways 558 may extend through the material splitter 516, each of the passageways 558 defined by the annular portion 550, the central portion 554, and the plurality of ribs 556. In some embodiments, the material splitter 516 may include a spike 560 extending longitudinally from an upper end of the central portion 554.

In some embodiments the entirety of the material splitter 516 may be a monolithic diamond structure, such as a polycrystalline diamond (“PCD”) structure. In further embodiments, the entirety of the material splitter 516 may be a polycrystalline cubic boron nitride (“PcBN”) structure.

Each of the passageways 558 may have an elongated arcuate cross-sectional shape with rounded ends. Each of the passageways 558 may be defined by a radially inner surface 562 defined by the central portion 554 of the material splitter 516, a radially outer surface 564 defined by the annular portion 550 of the material splitter 516, and two end surfaces 566 defined by the adjacent ribs 556 of the material splitter 516. The radially inner surface 562 may be shaped as a portion of a frustrum of a cone that is substantially coaxial to the longitudinal axis 565 of the material splitter 516 and having a first cone angle. The radially outer surface 564 may be shaped as a portion of a frustrum of a cone that is substantially coaxial to the longitudinal axis 565 of the material splitter 516 and having a second cone angle. Each of the two end surfaces 566 may be shaped as a portion of a frustrum of a cone or a portion of a cylinder and may provide a relatively smooth (e.g., rounded) transition between the radially inner surface 562 and the radially outer surface 564. Additionally, the first cone angle of the radially inner surface 562 may be smaller than the second cone angle of the radially outer surface 564.

Accordingly, an inlet opening 568 of each passageway 558 may be larger than an outlet opening 570 of each passageway 558 (e.g., the inlet opening 568 may have a larger cross-sectional area than the outlet opening 570). Additionally, each passageway 558 may extend radially inward from the inlet opening 568 to the outlet opening 570, and each of the passageways 558 may have a continuous taper from the inlet opening 568 to the outlet opening 570.

An edge of the inlet opening 568 and/or the outlet opening 570 of each of the passageways 558 may be radiused or chamfered. Additionally, a radially outer edge 572 of a lower end of the annular portion 550 may be a chamfered edge and/or a radiused edge.

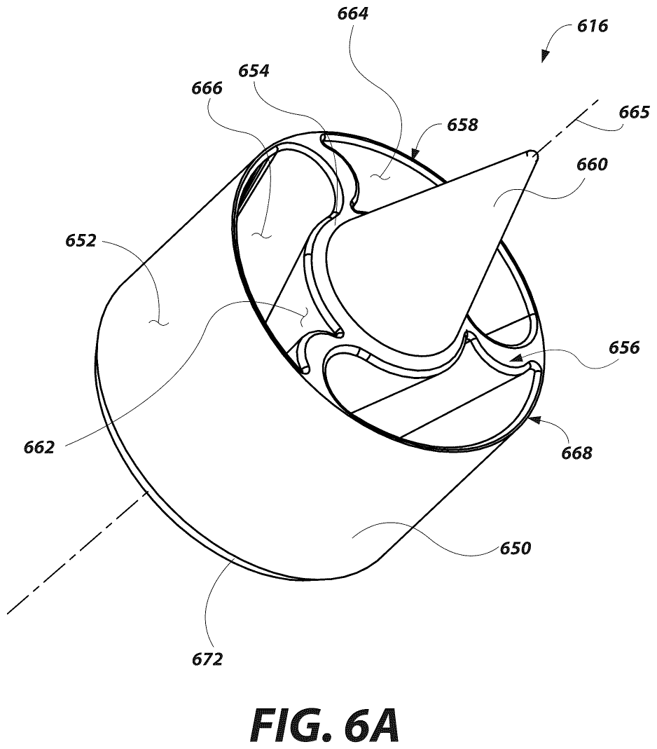

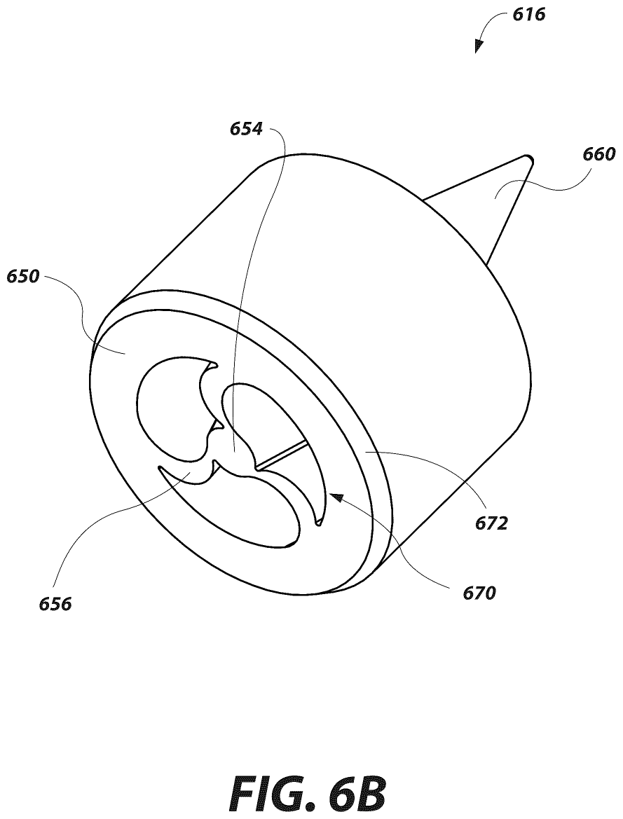

FIGS. 6A-6B illustrate a material splitter 616, which may be utilized in a nozzle assembly such as the nozzle assembly 100 of FIG. 1, which includes three passageways 658 in a spiral configuration according to an embodiment of the present disclosure. FIG. 6A is a top isometric view of the material splitter 616, and FIG. 6B is a bottom isometric view of the material splitter 616.

The material splitter 616 may be similar to the material splitter 516, except that a plurality of ribs 656 of the material splitter 616 may be configured differently than the plurality of ribs 556 of the material splitter 516. For example, each of the ribs 656 may be defined by end surfaces 566 that both curve in the same direction, rather than opposing directions, defining relatively thin curved ribs 656 that separate each passageway 658. Accordingly, the relatively thin curved ribs 656 can provide relatively large passageways 658. Additionally, each of the relatively thin curved ribs 656 may extend from an upper end to a lower end along a spiral or helical path. Thus, the passageways 658 defined by the ribs 656 may extend along a generally spiral or helical path. This configuration may provide improved flow and/or mixing of materials exiting the passageways 658.

Similar to the material splitter 516, the material splitter 616 may include an annular portion 650 having an outer surface 652 sized and configured for insertion into and to abut a bore of the nozzle body 110. A central portion 654 may be located at least partially within the annular portion 650 and the plurality of ribs 656 may extend laterally between and connect the annular portion 650 to the central portion 654. The plurality of passageways 658 may extend through the material splitter 616, each of the passageways 658 defined by the annular portion 650, the central portion 654, and the plurality of ribs 656. In some embodiments, the material splitter 616 may include a spike 660 extending longitudinally from an upper end of the central portion 654.

In some embodiments the entirety of the material splitter 616 may be a monolithic diamond structure, such as a polycrystalline diamond (“PCD”) structure. In further embodiments, the entirety of the material splitter 616 may be a polycrystalline cubic boron nitride (“PcBN”) structure.

Each of the passageways 658 may have an elongated arcuate cross-sectional shape with curved ends. Each of the passageways 658 may be defined by a radially inner surface 662 defined by the central portion 654 of the material splitter 616, a radially outer surface 664 defined by the annular portion 650 of the material splitter 616, and two end surfaces 666 defined by the adjacent ribs 656 of the material splitter 616. The radially inner surface 662 may be shaped as a portion of a frustrum of a cone that is substantially coaxial to the longitudinal axis 665 of the material splitter 616 and having a first cone angle. The radially outer surface 564 may be shaped as a portion of a frustrum of a cone that is substantially coaxial to the longitudinal axis 665 of the material splitter 616 and having a second cone angle. Each of the two end surfaces 666 may be shaped as a portion of a frustrum of a cone or a portion of a cylinder. Additionally, the first cone angle of the radially inner surface 662 may be smaller than the second cone angle of the radially outer surface 664.

Accordingly, an inlet opening 668 of each passageway 658 may be larger than an outlet opening 670 of each passageway 658 (e.g., the inlet opening 668 may have a larger cross-sectional area than the outlet opening 670). Additionally, each passageway 658 may extend radially inward from the inlet opening 668 to the outlet opening 670, and each of the passageways 658 may have a continuous taper from the inlet opening 668 to the outlet opening 670.

An edge of the inlet opening 668 and/or the outlet opening 670 of each of the passageways 658 may be radiused or chamfered. Additionally, a radially outer edge 672 of a lower end of the annular portion 650 may be a chamfered edge and/or a radiused edge.

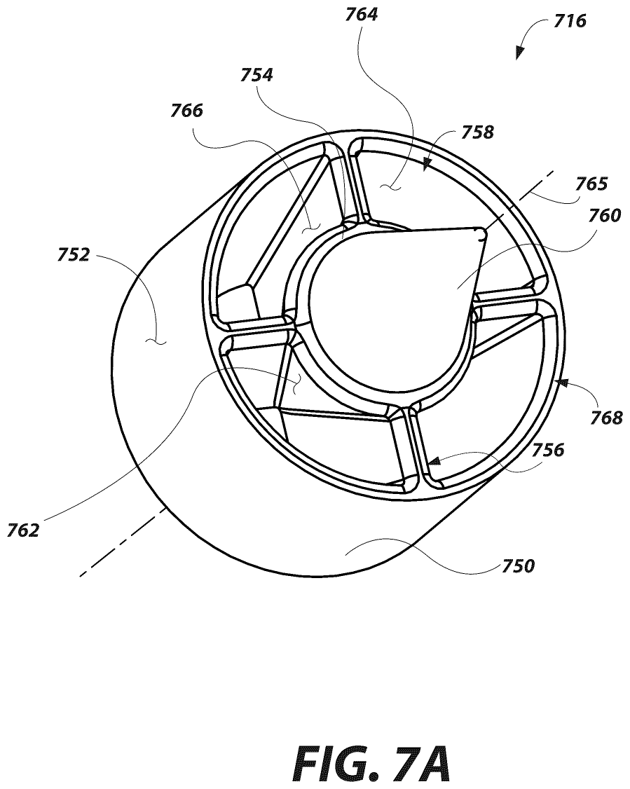

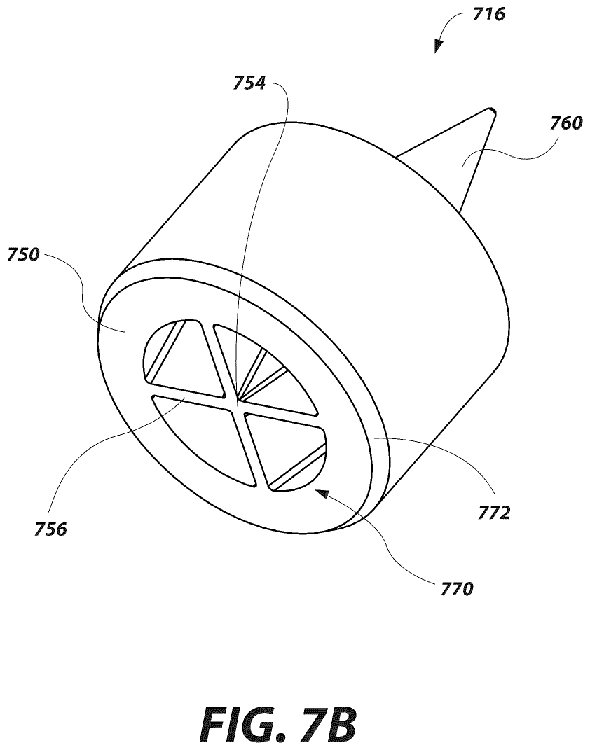

FIGS. 7A-7B illustrate a material splitter 716, which may be utilized in a nozzle assembly such as the nozzle assembly 100 of FIG. 1, which includes four passageways 758 divided by ribs 756 that are relatively narrow according to an embodiment of the present disclosure. FIG. 7A is a top isometric view of the material splitter 716, and FIG. 7B is a bottom isometric view of the material splitter 716.

The material splitter 716 may be similar to the material splitter 116, except that the plurality of ribs 756 of the material splitter 716 may be configured differently than the plurality of ribs 156 of the material splitter 116. For example, each of the ribs 756 may be defined by end surfaces 766 that are both substantially planar, radially extending surfaces, rather than opposing curved surfaces, defining relatively thin and flat ribs 756 that separate each passageway 758. Accordingly, the relatively thin and flat ribs 756 can provide relatively large passageways 758. Additionally, a radially inner surface 762 may taper to an apex where each of the ribs 756 may meet at the bottom of the material splitter 716. Thus, the passageways 758 defined by the ribs 756 and the radially inner surface 762 may be relatively large. This configuration may provide improved flow capacity through the material splitter 716.

Similar to the material splitter 116, the material splitter 716 may include an annular portion 750 having an outer surface 752 sized and configured for insertion into and to abut a bore of a nozzle body. A central portion 754 may be located at least partially within the annular portion 750 and the plurality of ribs 756 may extend laterally between and connect the annular portion 750 to the central portion 754. The plurality of passageways 758 may extend through the material splitter 716, each of the passageways 758 defined by the annular portion 750, the central portion 754, and the plurality of ribs 756. In some embodiments, the material splitter 716 may include a spike 760 extending longitudinally from an upper end of the central portion 754.

In some embodiments the entirety of the material splitter 716 may be a monolithic diamond structure, such as a polycrystalline diamond (“PCD”) structure. In further embodiments, the entirety of the material splitter 716 may be a polycrystalline cubic boron nitride (“PcBN”) structure.

Each of the passageways 758 may have an elongated arcuate cross-sectional shape with substantially flat and/or planar ends. Each of the passageways 758 may be defined by a radially inner surface 762 defined by the central portion 754 of the material splitter 716, a radially outer surface 764 defined by the annular portion 750 of the material splitter 716, and two end surfaces 766 defined by the adjacent ribs 756 of the material splitter 716. The radially inner surface 762 may be shaped as a portion of a frustrum of a cone that is substantially coaxial to the longitudinal axis 765 of the material splitter 716 and having a first cone angle. The radially outer surface 764 may be shaped as a portion of a frustrum of a cone that is substantially coaxial to the longitudinal axis 765 of the material splitter 716 and having a second cone angle. Each of the two end surfaces 766 may be substantially flat and/or planar. In some embodiments, the first cone angle of the radially inner surface 762 may be different than the second cone angle of the radially outer surface 764. In additional embodiments, the first cone angle of the radially inner surface 762 may be the same as the second cone angle of the radially outer surface 764.

Accordingly, in some embodiments, an inlet opening 768 of each passageway 758 may be larger than an outlet opening 770 of each passageway 758 (e.g., the inlet opening 768 may have a larger cross-sectional area than the outlet opening 770). In additional embodiments, the inlet opening 768 of each passageway 758 may be substantially the same size as the outlet opening 770 of each passageway 758 (e.g., the inlet opening 768 may have substantially the same cross-sectional area as the outlet opening 770). Additionally, each passageway 758 may extend radially inward from the inlet opening 768 to the outlet opening 770. In some embodiments, each of the passageways 758 may have a continuous taper from the inlet opening 768 to the outlet opening 770.

In some embodiments, some or all of the ribs 756 may extend laterally beyond the lateral extent of the annular portion 750. For example, some or all of the ribs 756 may extend laterally beyond the top of the annular portion 750 and connect to the spike 760. In some embodiments, an upper edge of some or all of the ribs 756 may be angled and extend from a location near the top edge of the annular portion 750 to the spike 760 and may extend to a location near the top of the spike 760. Additionally, an upper edge of some or all of the ribs 756 may be tapered to a relatively sharp edge. Such a configuration may increase the surface area of the ribs 756 and may facilitate the separation of material flowing through the material splitter 716 into the passageways 758.

An edge of the inlet opening 768 and/or the outlet opening 770 of each of the passageways 758 may be radiused or chamfered. Additionally, a radially outer edge 772 of a lower end of the annular portion 750 may be a chamfered edge and/or a radiused edge.

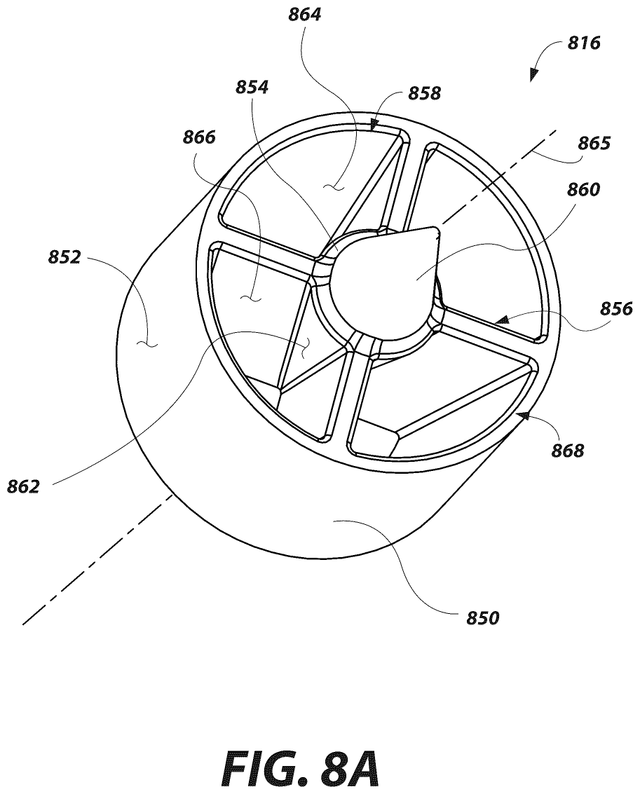

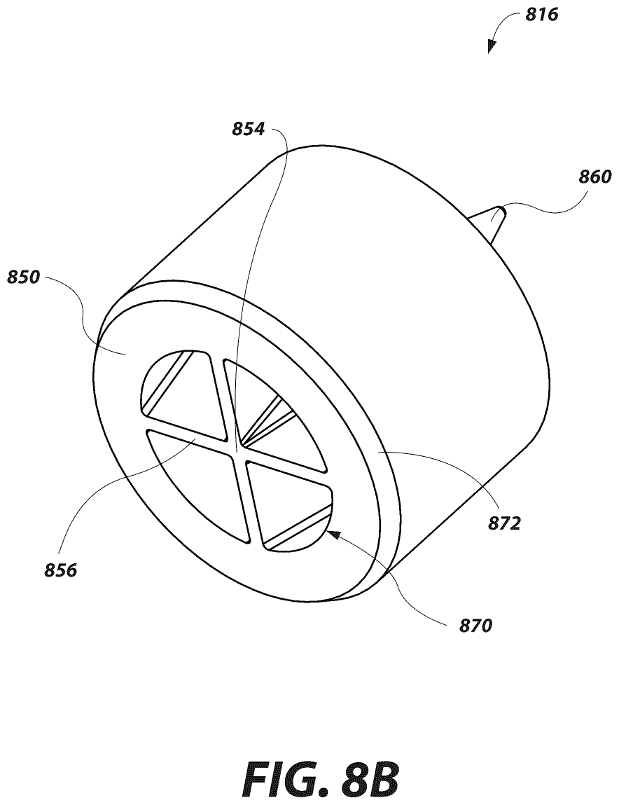

FIGS. 8A-8B illustrate a material splitter 816, which may be utilized in a nozzle assembly such as the nozzle assembly 100 of FIG. 1, which includes four passageways 858 divided by ribs 856 that are relatively narrow and includes a relatively small spike 860 according to an embodiment of the present disclosure. FIG. 8A is a top isometric view of the material splitter 816, and FIG. 8B is a bottom isometric view of the material splitter 816.

The material splitter 816 may be similar to the material splitter 716, except that the spike 860, a central portion 854, and radially inner surfaces 862 of the material splitter 816 may be configured to be substantially smaller than the spike 760, the central portion 754, and the radially inner surface 762 of the material splitter 716. Accordingly, the relatively small spike 860, central portion 854, and radially inner surfaces 862 of the material splitter 816 can provide even larger passageways 858, relative to the passageways 758 of the material splitter 716. Like the material splitter 716, the radially inner surface 862 may taper to an apex where each of the ribs 856 may meet at the bottom of the material splitter 816. Thus, the passageways 858 defined by the ribs 856 and the radially inner surface 862 may be relatively large when compared to the passageways 758 of the material splitter 716. This configuration may provide improved flow capacity through the material splitter 816 when compared to the material splitter 716.

Similar to the material splitter 716, the material splitter 816 may include an annular portion 850 having an outer surface 852 sized and configured for insertion into and to abut a bore of a nozzle body. A central portion 854 may be located at least partially within the annular portion 850 and the plurality of ribs 856 may extend laterally between and connect the annular portion 850 to the central portion 854. The plurality of passageways 858 may extend through the material splitter 816, each of the passageways 858 defined by the annular portion 850, the central portion 854, and the plurality of ribs 856. The relatively small spike 860 extending longitudinally from an upper end of the central portion 854.

In some embodiments the entirety of the material splitter 816 may be a monolithic diamond structure, such as a polycrystalline diamond (“PCD”) structure. In further embodiments, the entirety of the material splitter 816 may be a polycrystalline cubic boron nitride (“PcBN”) structure.

Each of the passageways 858 may have an elongated arcuate cross-sectional shape with substantially flat and/or planar ends. Each of the passageways 858 may be defined by a radially inner surface 862 defined by the central portion 854 of the material splitter 816, a radially outer surface 864 defined by the annular portion 850 of the material splitter 816, and two end surfaces 866 defined by the adjacent ribs 856 of the material splitter 816. The radially inner surface 862 may be shaped as a portion of a frustrum of a cone that is substantially coaxial to the longitudinal axis 865 of the material splitter 816 and having a first cone angle. The radially outer surface 864 may be shaped as a portion of a frustrum of a cone that is substantially coaxial to the longitudinal axis 865 of the material splitter 816 and having a second cone angle. Each of the two end surfaces 866 may be substantially flat and/or planar. In some embodiments, the first cone angle of the radially inner surface 862 may be different than the second cone angle of the radially outer surface 864. In additional embodiments, the first cone angle of the radially inner surface 862 may be the same as the second cone angle of the radially outer surface 864.

Accordingly, in some embodiments, an inlet opening 868 of each passageway 858 may be larger than an outlet opening 870 of each passageway 858 (e.g., the inlet opening 868 may have a larger cross-sectional area than the outlet opening 870). In additional embodiments, the inlet opening 868 of each passageway 858 may be substantially the same size as the outlet opening 870 of each passageway 858 (e.g., the inlet opening 868 may have substantially the same cross-sectional area as the outlet opening 870). Additionally, each passageway 858 may extend radially inward from the inlet opening 868 to the outlet opening 870. In some embodiments, each of the passageways 858 may have a continuous taper from the inlet opening 868 to the outlet opening 870.

An edge of the inlet opening 868 and/or the outlet opening 870 of each of the passageways 858 may be radiused or chamfered. Additionally, a radially outer edge 872 of a lower end of the annular portion 850 may be a chamfered edge and/or a radiused edge.

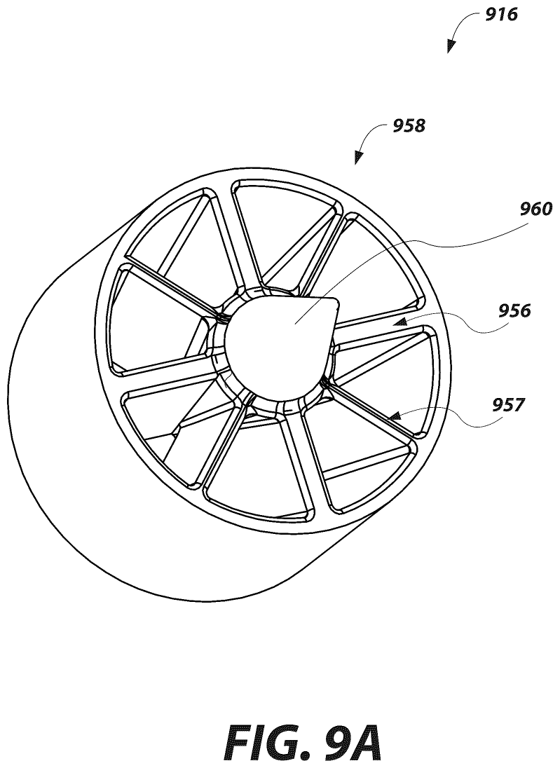

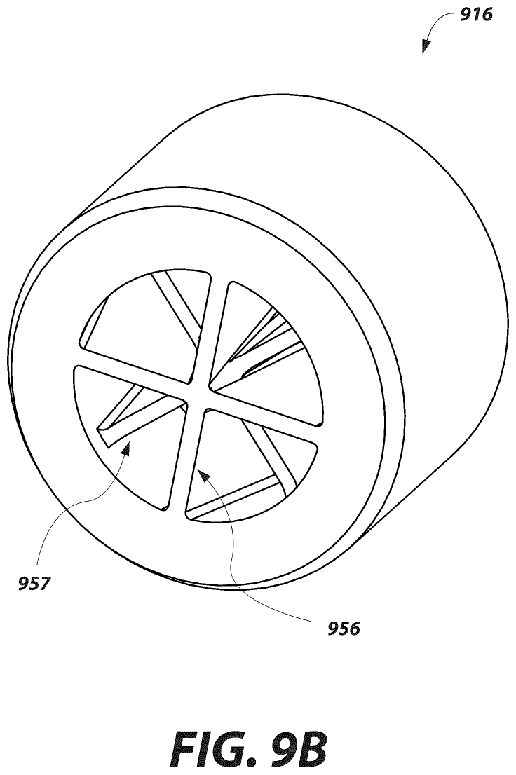

FIGS. 9A-9B illustrate a material splitter 916, which may be utilized in a nozzle assembly such as the nozzle assembly 100 of FIG. 1, which includes eight passageways 958 divided by ribs 956 that are relatively narrow and includes a relatively small spike 960 according to an embodiment of the present disclosure. FIG. 9A is a top isometric view of the material splitter 916, and FIG. 9B is a bottom isometric view of the material splitter 916.

The material splitter 916 may be similar to the material splitter 816, except that the material splitter 916 may be configured with a plurality of secondary ribs 957 in addition to a plurality of primary ribs 956, the primary ribs 956 being substantially the same as the ribs 856 of the material splitter 816 and the secondary ribs 957 being longitudinally shorter than the primary ribs 956 ending a distance from a bottom of the passageways 958 of the material splitter 916. Accordingly, the plurality of secondary ribs 957 may provide additional surface area for transfer of heat from the material splitter 916 to material passing through the passageways 958 without restricting flow near an exit of the passageways 958. This configuration may provide improved flow capacity through the material splitter 916 while providing additional heat transfer between the material splitter 916 and material flowing through the material splitter 916 when compared to the material splitter 816.

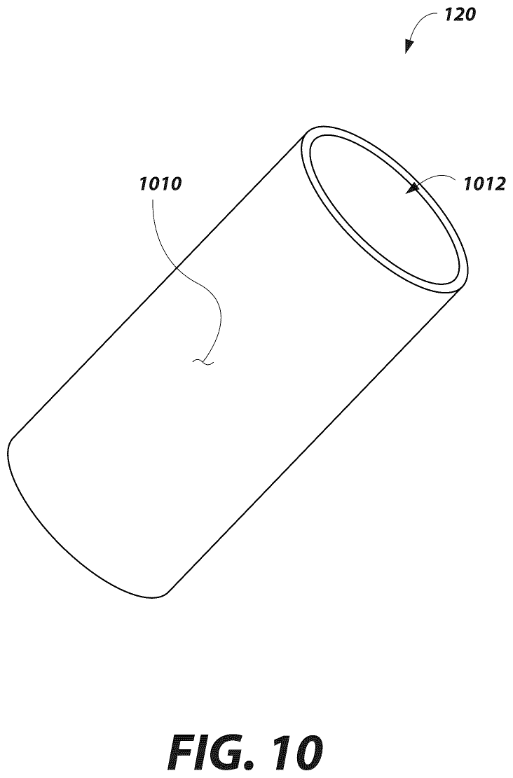

FIG. 10 illustrates an isometric view of the hollow sleeve 120 of the nozzle assembly 100 of FIG. 1, which may comprise a superhard material (e.g., hollow sleeve 120 may be formed of a superhard material) according to an embodiment of the present disclosure.

The hollow sleeve 120 may have an outer surface 1010 sized and shaped to conform to an inner surface of the recess 126 of the nozzle body 110 (see FIG. 1) and may have a passageway 1012 extending longitudinally through the hollow sleeve 120. For example, the hollow sleeve 120 may be shaped as a hollow cylinder (e.g., a cylindrical pipe). A longitudinal length of the hollow sleeve 120 may be sized to extend from the material splitter 116 to a location at or near an opening of the recess 126 of the nozzle body 110.

The superhard material of the hollow sleeve 120 may be selected to provide a robust resistance to wear that may otherwise occur via the movement of printing material through the hollow sleeve 120 during additive manufacturing operations. Additionally, the superhard material of the hollow sleeve 120 may be selected to have a relatively high thermal conductivity, which may efficiently transfer heat through the hollow sleeve 120 from the nozzle body 110 to the printing material flowing through the hollow sleeve 120 during additive manufacturing operations to facilitate the melting of the printing material. Furthermore, the superhard material of the hollow sleeve 120 may be selected to provide a surface interface between the hollow sleeve 120 and the printing material with a relatively low coefficient of friction (e.g., a relatively low static friction coefficient and/or a relatively low dynamic friction coefficient), which may facilitate the efficient flow of printing material.

In some embodiments the entirety of the hollow sleeve 120 may be a monolithic diamond structure, such as a polycrystalline diamond (“PCD”) structure. In further embodiments, the entirety of the hollow sleeve 120 may be a polycrystalline cubic boron nitride (“PcBN”) structure.

FIG. 11 is a cross-sectional view of a nozzle assembly 1100 including a nozzle body 1110, a nozzle 1114, a hollow sleeve 1120, and a plurality of material splitters 1116, 1118, according to an embodiment of the present disclosure.

The nozzle assembly 1100 may include one or more feature that is substantially the same as the nozzle assembly 100, but may include a plurality of material splitters 1116, 1118 in a stacked configuration, and may include a hollow sleeve 1120 that is shorter than the hollow sleeve 120 to accommodate the stacked material splitters 1116, 1118. The material splitter 1116 may include one or more feature that is substantially the same as the material splitter 116. The material splitter 1118 may include one or more feature that is substantially the same as the material splitter 116 except that the material splitter 1118 may lack a spike (e.g., like the spike 160), and may rather have a substantially planar surface 1146 located at an upper end of a central portion 1154 to facilitate the stacking of the material splitter 1116 thereon.

By including the plurality of material splitters 1116, 1118, the nozzle assembly 1100 may provide additional heat transfer to printing material flowing through the nozzle assembly 1100 (e.g., compared to a nozzle assembly with a single material splitter or lacking a material splitter) as the printing material flows through the plurality of material splitters 1116, 1118 which may provide improved liquification of the printing material within the nozzle assembly 1100 and/or a relatively high flowrate of printing material through the nozzle assembly 1100.

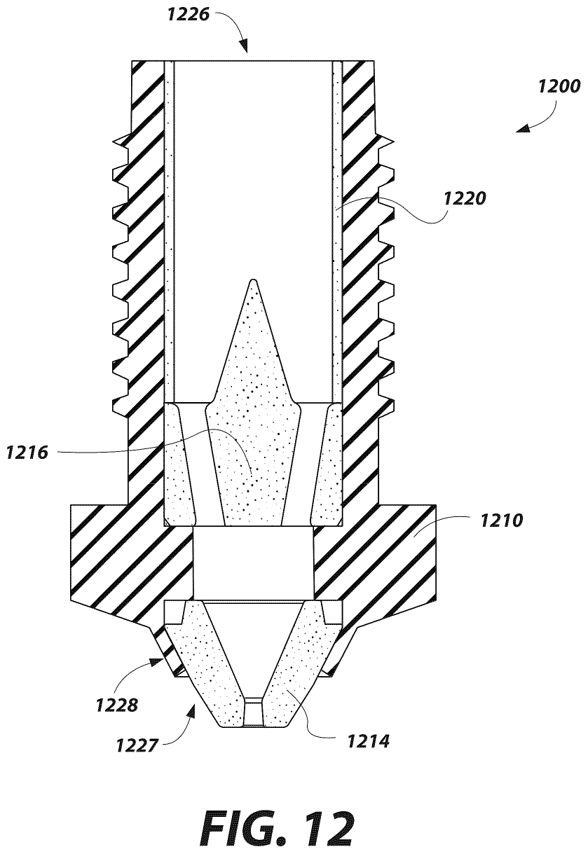

FIG. 12 is a cross-sectional view of a nozzle assembly 1200 with a nozzle body 1210 having a material splitter 1216 and hollow sleeve 1220 located in a first recess 1226 and a nozzle 1214 located in a second recess 1227, according to an embodiment of the present disclosure.

The nozzle 1214 may include one or more feature that is substantially the same as the nozzle 114, the material splitter 1216 may include one or more feature that is substantially the same as the material splitter 116, and the hollow sleeve 1220 may include one or more feature that is substantially the same as the hollow sleeve 120.

Similar to the nozzle assembly 100, the nozzle body 1210 of the nozzle assembly 1200 may be configured to attach to one or more components of a 3D printer, such as a material heater and/or a material feeder, so that the nozzle assembly 1200 may be utilized as a part of the 3D printer to dispense printing material for additive manufacturing.

The nozzle body 1210 may include the first recess 1226 extending longitudinally into the nozzle body 1210 along a central longitudinal axis from an upper end. The first recess 1226 may be sized to receive the material splitter 1216 and the hollow sleeve 1220.

The nozzle body 1210 may additionally include the second recess 1227 extending longitudinally into the nozzle body 110 along a central longitudinal axis from a lower end. The second recess 1227 may be sized to receive the nozzle 1214.

The material splitter 1216 and the hollow sleeve 1220 may be secured within the first recess 1226 in substantially the same manner described herein relative to the material splitter 116 and the hollow sleeve 120 of the nozzle assembly 100 being secured within the recess 126. The nozzle 1214 may be secured within the second recess 1227 by press fitting, a threaded coupler, brazing, soldering, adhesively adhering, and/or swaging. For example, a wall 1228 extending from an end of the nozzle body 1210 may be swaged to extend over a surface of the nozzle 1214.

As depicted, the material splitter 1216 may be separated from the nozzle 1214, for example, by a shoulder of the nozzle body 1210.

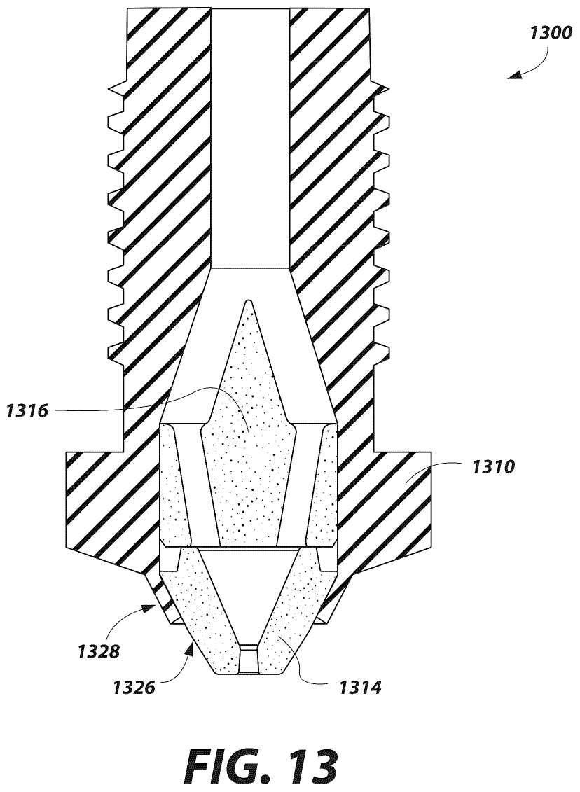

FIG. 13 is a cross-sectional view of a nozzle assembly 1300 with a nozzle 1314 retaining a material splitter 1316 within a recess 1326 of a nozzle body 1310, according to an embodiment of the present disclosure.

The nozzle 1314 may include one or more feature that is substantially the same as the nozzle 114, and the material splitter 1316 may include one or more feature that is substantially the same as the material splitter 116.

As described herein with respect to the nozzle assembly 100, the nozzle body 1310 of the nozzle assembly 1300 may be configured to attach to one or more components of a 3D printer, such as a material heater and/or a material feeder, so that the nozzle assembly 1300 may be utilized as a part of the 3D printer to dispense printing material for additive manufacturing.

The nozzle body 1310 may include a recess 1326 extending longitudinally into the nozzle body 1310 along a central longitudinal axis from a lower end. The recess 1326 may be sized to receive the material splitter 1316 and the nozzle 1314. However, a remaining portion of the recess 1326 may reduce in diameter such that the material splitter 1316 abuts a reduced diameter portion of the nozzle body 1310.

The material splitter 1316 and the nozzle 1314 may be secured within the recess 1326 by, for example, press fitting, a threaded coupler, brazing, soldering, welding, adhesively adhering, swaging, contact with another component of a nozzle assembly, and/or any combination of any of the foregoing or any equivalent to the foregoing. For example, a wall 1328 extending from an end of the nozzle body 1310 may be swaged to extend over a surface of the nozzle 1314, securing both the nozzle 1314 and the material splitter 1316 within the recess 1326.

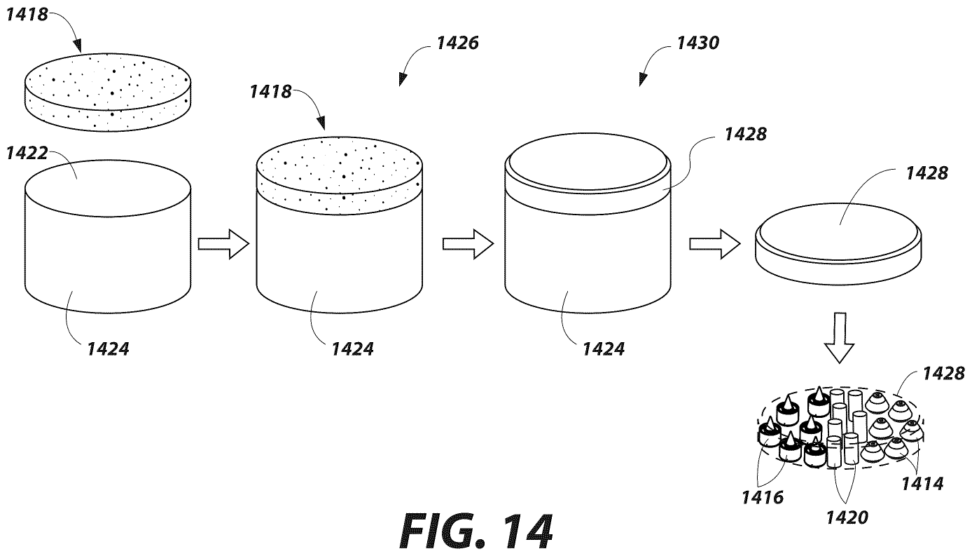

FIG. 14 is a schematic illustration of an embodiment of a method for fabricating one or more material splitters, nozzles, and/or hollow sleeves comprising a superhard material, such as PCD, according to embodiments of the present disclosure. It is noted that the method illustrated in FIG. 14 may be used to form any of the material splitters, nozzles, and/or hollow sleeves disclosed herein.

Referring to FIG. 14, a mass of diamond particles 1418 is provided. The diamond particles 1418 may exhibit an average particle size of about 50 μm or less, such as about 40 μm or less, about 30 μm or less, about 20 μm or less, about 10 μm to about 18 μm, or about 15 μm to about 18 μm. In some embodiments, the average particle size of the diamond particles 1418 may be about 10 μm or less, such as about 2 μm to about 5 μm or submicron. The average particle size of the diamond particles 1418 may be selected to minimize volume loss of the material splitters, nozzles, and/or hollow sleeves formed thereby. For example, it has been found that the printing material flowing through the material splitters, nozzles, and/or hollow sleeves may cause some of the diamond grains to become dislodged thereby resulting in volume loss (i.e., wear) of the material splitters, nozzles, and/or hollow sleeves. To minimize volume loss, the diamond particles 1418 may be selected to exhibit an average particle size that is less than 40 μm such that dislodging one or a few diamond grains has negligible effect on the volume of the material splitters, nozzles, and/or hollow sleeves. However, it is noted that decreasing the average particle size of the diamond particles 1418 may further limit volume loss and, as such, the diamond particles 1418 may be selected to exhibit an average particle size that is significantly less than 40 μm, such as less than 20 μm or less than 10 μm.

In an embodiment, the diamond particles 1418 may comprise a relatively larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the mass of diamond particles 1418 may include a portion exhibiting a relatively larger size (e.g., 30 μm, 20 μm, 15 μm, 12 μm, 10 μm, 8 μm) and another portion exhibiting at least one relatively smaller size (e.g., 6 μm, 5 μm, 4 μm, 3 μm, 2 μm, 1μm, 0.5 μm, less than 0.5 μm, 0.1 μm, less than 0.1 μm). In one embodiment, the mass of diamond particles 1418 may include a portion exhibiting a relatively larger size between about 10 μm and about 40 μm and another portion exhibiting a relatively smaller size between about 0.5 μm and 4 μm. In some embodiments, the mass of diamond particles 1418 may comprise three or more different sizes (e.g., one relatively larger size and two or more relatively smaller sizes), without limitation. It is noted that the as-sintered diamond grain size may differ from the average particle size of the mass of diamond particles prior to sintering due to a variety of different physical processes, such as grain growth, diamond particles fracturing, carbon provided from another carbon source (e.g., dissolved carbon in the metal-solvent catalyst), or combinations of the foregoing.

The mass of diamond particles 1418 may be positioned adjacent to the interfacial surface 1422 of the substrate 1424 to form an assembly 1426. The substrate 1424 may include, without limitation, cemented carbides, such as tungsten carbide, titanium carbide, chromium carbide, niobium carbide, tantalum carbide, vanadium carbide, or combinations thereof cemented with iron, nickel, cobalt, or alloys thereof. For example, in one embodiment, the substrate 1424 comprises cobalt-cemented tungsten carbide. The substrate 1424 may be generally cylindrical or another selected configuration, without limitation. Although FIG. 13 shows an interfacial surface 1422 of the substrate 1424 as being substantially planar, the interfacial surface 1422 may exhibit a selected nonplanar topography, such as a grooved, ridged, or other nonplanar interfacial surface.

The assembly 1426 also includes a catalyst configured to sinter the mass of diamond particles 1418. The catalyst may be provided in particulate form mixed with the mass of diamond particles 1418, as a thin foil or plate placed adjacent to the mass of diamond particles 1418, from the substrate 1424 (e.g., the substrate 1424 is a cemented carbide substrate including a metal-solvent catalyst), or combinations thereof. In an embodiment, the catalyst includes a metal-solvent catalyst (e.g., iron, nickel, cobalt, or alloys thereof). In an embodiment, the catalyst includes at least one nonmetallic catalyst selected from one or more of alkali metal carbonate (e.g., one or more carbonates of Li, Na, and K), one or more alkaline earth metal carbonates (e.g., one or more carbonates of Be, Mg, Ca, Sr, and Ba), a sulfate (e.g., one or more sulfates of Be, Mg, Ca, Sr, and Ba), a hydroxide (e.g., one or more hydroxides of Be, Mg, Ca, Sr, and Ba), elemental phosphorous and/or a derivative thereof, a chloride (e.g., one or more chlorides of Li, Na, and K), elemental sulfur and/or a derivative thereof, a polycyclic aromatic hydrocarbon (e.g., naphthalene, anthracene, pentacene, perylene, coronene, or combinations of the foregoing) and/or a derivative thereof, a chlorinated hydrocarbon and/or a derivative thereof, a semiconductor material (e.g., germanium or a geranium alloy), and combinations of the foregoing. In an example, the catalyst includes one or more metal-solvent catalysts and one or more nonmetallic catalysts.

In order to efficiently sinter the mass of diamond particles 1418, the assembly 1426 may be enclosed in a pressure transmitting medium, such as a refractory metal can, graphite structure, pyrophyllite, and/or other suitable pressure transmitting structure to form a cell assembly. Examples of suitable gasket materials and cell structures for use in manufacturing PCD are disclosed in U.S. Pat. No. 6,338,754 and U.S. Pat. No. 8,236,074, each of which is incorporated herein, in its entirety, by this reference. Another example of a suitable pressure transmitting material is pyrophyllite, which is commercially available from Wonderstone Ltd. of South Africa.

The cell assembly 1426, including the pressure transmitting medium and mass of diamond particles 1418 therein, is subjected to an HPHT process using an ultra-high pressure press at a temperature of at least about 1200° C. (e.g., about 1300° C. to about 2200° C., or about 1400° C. to about 1450° C.) and a pressure in the pressure transmitting medium of at least about 7.5 GPa (e.g., about 7.5 GPa to about 15 GPa, at least about 8.0 GPa, at least about 9.0 GPa, at least about 10.0 GPa, at least about 11.0 GPa, at least about 12.0 GPa, or at least about 14 GP) for a time sufficient to sinter the diamond particles 1418 together in the presence of the catalyst and form the PCD table 1428 comprising bonded diamond grains defining interstitial regions occupied by the catalyst. The HPHT process may form a PCD compact (PDC) 230 that includes the PCD table 1428 bonded to the substrate. During the HPHT process, the catalyst may liquefy and, if the catalyst is disposed outside the diamond particles 1418, the catalyst may infiltrate the mass of diamond particles 1418. The catalyst promotes growth between adjacent diamond particles of the mass of diamond particles 1418 to form the PCD table 1428 comprised of a body of bonded diamond grains having the infiltrated catalyst interstitially disposed between bonded diamond grains. For example, if the substrate 1424 is a cobalt-cemented tungsten carbide substrate, cobalt from the substrate 1424 may be liquefied and infiltrate the mass of diamond particles 1418 to catalyze formation of the PCD table 1428. As used herein, the phrase “PCD table” refers to a volume, mass, or slug of polycrystalline diamond of undefined shape. For example, a PCD table may refer to a polycrystalline diamond layer that is attached to a substrate during HPHT sintering. In another example, a PCD table may refer to a solid piece of HPHT sintered polycrystalline diamond, without limitation.

The pressure values employed in the HPHT processes disclosed herein refer to the pressure in the pressure transmitting medium at room temperature (e.g., about 25° C.) with application of pressure using an ultra-high pressure press and not the pressure applied to exterior of the cell assembly 1426. The actual pressure in the pressure transmitting medium at sintering temperature may be slightly higher. The ultra-high pressure press may be calibrated at room temperature by embedding at least one calibration material that changes structure at a known pressure, such as PbTe, thallium, barium, or bismuth in the pressure transmitting medium. Further, optionally, a change in resistance may be measured across the at least one calibration material due to a phase change thereof. For example, PbTe exhibits a phase change at room temperature at about 6.0 GPa and bismuth exhibits a phase change at room temperature at about 7.7 GPa. Examples of suitable pressure calibration techniques are disclosed in G. Rousse, S. Klotz, A. M. Saitta, J. Rodriguez-Carvajal, M. I. McMahon, B. Couzinet, and M. Mezouar, “Structure of the Intermediate Phase of PbTe at High Pressure,” Physical Review B: Condensed Matter and Materials Physics, 71, 224116 (2005) and D. L. Decker, W. A. Bassett, L. Merrill, H. T. Hall, and J. D. Barnett, “High-Pressure Calibration: A Critical Review,” J. Phys. Chem. Ref. Data, 1, 3 (1972).

In other embodiments, a PCD table 1428 according to an embodiment may be separately formed using an HPHT sintering process and, subsequently, bonded to the interfacial surface 1422 of the substrate 1424 by brazing, using a separate HPHT bonding process, or any other suitable joining technique, without limitation. In yet another embodiment, a substrate 1424 may be formed by depositing a binderless carbide (e.g., tungsten carbide) via chemical vapor deposition onto the separately formed PCD table 1428.

In any of the embodiments disclosed herein, substantially all or a selected portion of the catalyst (e.g., metal-solvent catalyst) may be removed (e.g., via leaching) from the PCD table 1428. In an embodiment, metal-solvent catalyst in the PCD table 1428 may be removed to a selected depth from at least one exterior working surface (e.g., the working surface and/or a sidewall working surface of the PCD table 1428) so that only a portion of the interstitial regions are occupied by metal-solvent catalyst. For example, substantially all or a selected portion of the metal-solvent catalyst may be removed from the PCD table 1428 so-formed in the PDC 1430 to a selected depth from the working surface.

In another embodiment, a PCD table 1428 may be fabricated according to any of the disclosed embodiments in a first HPHT process, leached to remove substantially all of the metal-solvent catalyst from the interstitial regions between the bonded diamond grains, and subsequently bonded to a substrate in a second HPHT process. In the second HPHT process, an infiltrant from, for example, a cemented carbide substrate may infiltrate into the interstitial regions from which the metal-solvent catalyst was depleted. For example, the infiltrant may be cobalt that is swept-in from a cobalt-cemented tungsten carbide substrate. In one embodiment, the first and/or second HPHT process may be performed at a pressure of at least about 7.5 GPa. In one embodiment, the infiltrant may be leached from the infiltrated PCD table 1428 using a second acid leaching process following the second HPHT process.

In an embodiment, the PCD table 1428 may be a binderless PCD table. The binderless PCD table may be formed by pressing a mass of diamond particles with or without additives such as a catalyst. The diamond particles are pressed without any metal-solvent catalyst being present. For example, the mass of diamond particles may not be disposed on a cobalt-cemented tungsten carbide substrate. The binderless PCD table may be pressed using any of the pressures and temperatures disclosed herein.

In an embodiment, as shown, the substrate 1424 may be removed or otherwise detached from the PCD table 1428. For example, the substrate 1424 may be removed from the PCD table 1428 by grinding the substrate 1424 or dissolving the substrate 1424 in an acid. In an embodiment, not shown, at least a portion of the substrate 1424 is not removed or otherwise detached from the PCD table 1428. In such an embodiment, the substrate 1424 may form a portion of the material splitters, nozzles, and/or hollow sleeves formed from the PCD table 1428.

The PCD table 1428 may then be utilized as a precursor structure for forming material splitters, nozzles, and/or hollow sleeves, according to embodiments of the present disclosure.

Portions of the PCD table 1428 and, optionally, the substrate 1424 may be removed to form one or more nozzles 1414 (which may be, for example, any of nozzles 114, 1114, 1314, 1414), material splitters 1416 (which may be, for example, any of material splitters 116, 216, 1116, 1118, 1316, 1416), and/or hollow sleeves 1420 (which may be, for example, any of hollow sleeves 120, 1120, 1220). For example, portions of the PCD table 1428 and, optionally, the substrate 1424 may be removed to form 1, 2, 3, 4, 5, 6, 7, 8, 9, 10, 11, 12, 13, 14, 15, 16, 17, 18, 19, 20, or greater than 20 nozzles 1414, material splitters 1416, and/or hollow sleeves 1420. The number of nozzles 1414, material splitters 1416, and/or hollow sleeves 1420 formed from the PCD table 1428 and, optionally, the substrate 1424 may depend on the size (e.g., maximum lateral dimension and thickness) and shape of the PCD table 1428, the size and shape of the nozzles 1414, material splitters 1416, and/or hollow sleeves 1420, and whether the substrate 1424 forms a portion of the nozzles 1414, material splitters 1416, and/or hollow sleeves 1420. It is noted that nozzles 1414, material splitters 1416, and/or hollow sleeves 1420 formed from the PCD table 1428 and, optionally, the substrate 1424 may include one or more feature that is the same or substantially similar to any one or more feature of the nozzles disclosed herein, without limitation.

In an embodiment, the portions of the PCD table 1428 and, optionally, the substrate 1424 may be removed using a laser. In such an embodiment, the laser may emit a plurality of laser pulses towards one or more surfaces of the PCD table 1428 and, optionally, the substrate 1424. The laser pulses may be selected to remove the PCD table 1428 in one or more layers. The laser ablation process may accomplish at least one of the following: form a plurality of nozzles 1414, material splitters 1416, and/or hollow sleeves 1420 from the PCD table 1428 (e.g., simultaneously or substantially simultaneously) form the exterior features (e.g., top surface, bottom surface, nozzle lateral surface, etc.), form interior features (e.g., passageways) of the nozzles 1414, material splitters 1416, and/or hollow sleeves 1420, or polish the surfaces of the nozzles 1414, material splitters 1416, and/or hollow sleeves 1420. Examples of lasing methods that may be used to remove portions of the PCD table 1428 are disclosed in U.S. patent application Ser. No. 16/084,469 filed on Jan. 10, 2018, the disclosure of which is incorporated herein, in its entirety, by this reference.

In an embodiment, the portions of the PCD table 1428 and, optionally, the substrate 1424 may be removed using one or more of grinding, lapping, laser ablation, electrical discharge machining (e.g., wire electrical discharge machining), combinations of the foregoing, or any other machining technique. Unlike lasing, some machining techniques such as grinding, lapping, and electrical discharge machining may at least one of exhibit high wear due to the hardness of diamond, may be unable to form all of the nozzles 1414, material splitters 1416, and/or hollow sleeves 1420 collectively (e.g., in a single process), form both the exterior and interior features of the nozzles 1414, material splitters 1416, and/or hollow sleeves 1420, or polish the surfaces of the nozzles 1414, material splitters 1416, and/or hollow sleeves 1420. In an embodiment, the portions of the PCD table 1428 and, optionally, the substrate 1424 may be removed using lasing and one or more of grinding, lapping, electrical discharge machining, or any other machining technique.

In further embodiments, nozzles, material splitters, and/or hollow sleeves according to embodiments of the present disclosure may be at least partially formed from PcBN instead of or in addition to PCD. More generally, nozzles, material splitters, and/or hollow sleeves disclosed herein may comprise one or more superhard material (e.g., PCD, PCBN, silicon carbide, or any material having a hardness exceeding the hardness of tungsten carbide), without limitation. For example, the nozzles, material splitters, and/or hollow sleeves may be at least partially formed from PcBN due the hardness and thermal conductivity of PcBN, which is comparable to the hardness and thermal conductivity of PCD. Being formed from PcBN may decrease the wear, may increase the lifespan, may allow use with abrasive printing materials, and may improve the consistency of the printing material formed using 3D printers including such nozzles, material splitters, and/or hollow sleeves. The PcBN may exhibit a thermal stability that is greater than PCD thereby allowing nozzles, material splitters, and/or hollow sleeves formed from PcBN to be heated to greater temperatures than PCD. For example, PCD may exhibit thermal degradation when heated to a temperature that is greater than 700° C. when the PCD includes a metal-solvent catalyst and the PcBN may be heated to temperatures that are greater than 700° C. substantially without degradation.

In some embodiments, a nozzle, material splitter, and/or hollow sleeve may be formed entirely from PcBN. Forming all of the nozzle, material splitter, and/or hollow sleeve from PcBN may make manufacturing easier since there is no need to attach the PcBN to another material and may improve the wear characteristics. In another embodiment, only a portion of the nozzle, material splitter, and/or hollow sleeve may be formed from PcBN. Forming only a portion from PcBN may make shaping and machining the nozzle, material splitter, and/or hollow sleeve easier since the other materials may be less hard than the PcBN. However, forming only a portion of the nozzle, material splitter, and/or hollow sleeve from PcBN may require bonding the PcBN to another material thereby increasing the complexity of manufacturing. Also, the fact that portions of the nozzle, material splitter, and/or hollow sleeve comprise (or are formed from) a material that is less hard than PcBN may increase wear on portions that comprise (or are formed from) the less hard material thereby decreasing the lifespan of the nozzle, material splitter, and/or hollow sleeve.

The PcBN may be formed by heating boron nitride at any of the same temperatures and pressures discussed above, such as a temperature of about 1200° C. to about 1450° C. and a pressure of about 5 GPa to about 14 GPa. Catalysts for PcBN include, for example, alkali metals, antimony, lead, tin, lithium, magnesium, and nitrides. After forming the PcBN, one or more nozzles, material splitters, and/or hollow sleeves may be formed therefrom using the same techniques disclosed above with regards to PCD. For example, the nozzles may be formed by lasing, grinding, lapping, electrical discharge machining, or any other suitable machining technique.

As previously discussed, nozzle assemblies according to embodiments of the present disclosure, such as nozzle assemblies 100, 1100, 1200, 1300, and/or components thereof may be utilized in a printing device. The printing device may include any device that is configured to receive the nozzle assembly and perform 3D printing. For example, the printing device may include a platform that is configured to have a material printed therein and a support that is configured to support the nozzle assembly above the platform. At least one of the platform or the support may be configured to move relative to each other. During use, the printing device may provide a printing material to the nozzle assembly. The printing material may include one or more polymer, one or more metal, one or more ceramic, and/or combinations thereof. The printing material may flow through the nozzle assembly (e.g., through the base, the hollow sleeve, the material splitter, and/or the nozzle) and be dispensed on the platform to form a desired structure.

Referring again to FIG. 1, when a nozzle assembly 100 is incorporated in a 3D printer and used in printing operations, printing material may be fed into the nozzle assembly 100 via a material feeder (not shown) that may incrementally feed a filament of printing material into the nozzle assembly 100.

As the printing material enters the hollow sleeve 120 of the nozzle assembly 100, the printing material may be heated, such as by a heater (not shown) coupled to the nozzle assembly 100 and or adjacent to the nozzle assembly 100, and may begin to soften and melt as it flows through the hollow sleeve 120. The superhard material of the hollow sleeve 120 may have a relatively high thermal conductivity and may have a relatively small coefficient of friction, which may accelerate the heating of the printing material within the hollow sleeve 120 and may facilitate a relatively high flow rate of the printing material through the hollow sleeve 120. Upon contacting the spike 160 of the material splitter 116, the printing material may expand and begin to split and may flow over the spike 160 and may be fed through the passageways 158.

Within the passageways 158 the printing material may be further heated. The heating of the printing material within the passageways 158 may be relatively efficient, as the superhard material of the material splitter 116 may have a relatively high thermal conductivity and as the surface contact area of the printing material flowing through the passageways 158 relative to the volume may be relatively high (e.g., as compared to the same volume of printing material flowing through a single flow path). In addition to providing improved heat transfer to the printing material, the material splitter 116 may reduce a thermal gradient within the printing material.

Printing material being heated within a channel (without any material splitter) having a relatively high volume relative to the surface area of the printing material in contact with the channel may experience a relatively high thermal gradient. That is to say that the volume of printing material in proximity to the wall of the channel may be at a significantly higher temperature than the volume of printing material that is distal to the wall of the channel (e.g., printing material located at the center of the flow). Accordingly, it may be necessary to slow the flow of the printing material so that the entirety of the printing material may reach a sufficiently high temperature for printing operations, which may reduce the speed of printing operations and be costly and time consuming. Additionally, if printing material is fed at relatively high flow rates, at least a portion of the printing material may not be heated sufficiently and the printing operations may fail, which may also be costly and time consuming.

A material splitter according to some embodiments of the present disclosure may increase the contact surface area (e.g., the surface area that may contact material passing through) in a location of a channel where the material splitter is located (e.g., compared to the same location of the channel without a material splitter) to be more than about 1.5 times the area, more than about 1.9 times the area, more than about 2 times the area, more than about 2.3 times the area, more than about 2.4 times the area, more than about 2.75 times the area, more than about 2.8 times the area, more than about 3 times the area, more than about 3.5 times the area, and/or more than about 3.65 times the area.

For example, in some embodiments, the material splitter 116 shown in FIGS. 3A-3D may provide a contact surface area in a location of a channel where the material splitter 116 is located that is about 191% the contact area of the channel at that location without the material splitter 116. For another example, in some embodiments, the material splitter 216 shown in FIGS. 4A-4D may provide a contact surface area in a location of a channel where the material splitter 216 is located that is about 230% the contact area of the channel at that location without the material splitter 216. For another example, in some embodiments, the material splitter 516 shown in FIGS. 5A-5B may provide a contact surface area in a location of a channel where the material splitter 516 is located that is about 243% the contact area of the channel at that location without the material splitter 516. For another example, in some embodiments, the material splitter 616 shown in FIGS. 6A-6B may provide a contact surface area in a location of a channel where the material splitter 616 is located that is about 277% the contact area of the channel at that location without the material splitter 616. For another example, in some embodiments, the material splitter 716 shown in FIGS. 7A-7B may provide a contact surface area in a location of a channel where the material splitter 716 is located that is about 205% the contact area of the channel at that location without the material splitter 716. For another example, in some embodiments, the material splitter 816 shown in FIGS. 8A-8B may provide a contact surface area in a location of a channel where the material splitter 816 is located that is about 283% the contact area of the channel at that location without the material splitter 816. For another example, in some embodiments, the material splitter 916 shown in FIGS. 9A-9B may provide a contact surface area in a location of a channel where the material splitter 916 is located that is about 366% the contact area of the channel at that location without the material splitter 916.

In some embodiments, material splitters and/or nozzles according to embodiments of the present disclosure (e.g., material splitters 116, 216, 516, 616, 716, 816, 916 and/or nozzle 114) may include a texture on one or more surfaces that may contact material flowing therethrough to increase the surface area, which may improve heat transfer. For example, one or more texture may be applied such as described in U.S. Pat. No. 7,464,973 to Chapman et al., granted Dec. 16, 2008, and/or U.S. Pat. No. 4,629,373 to Hall, granted Dec. 16, 1986, each of which are hereby incorporated by reference herein in their entirety.

The material splitter 116 may improve heat transfer to and reduce the thermal gradient in the printing material in many ways. For example, improved heat transfer to and reduced the thermal gradient in the printing material may be provided by relatively high thermal conductivity of the material splitter 116. For another example, improved heat transfer to and a reduction in the thermal gradient in the printing material may be provided by relatively high surface contact area of the printing material with the material splitter 116. For yet another example, improved heat transfer to and reduced the thermal gradient in the printing material may be provided by the splitting of printing material flow entering the material splitter 116 and the rejoining of printing material flow after exiting the material splitter 116 mixing the printing material within the nozzle assembly 100.

After the printing material has exited the material splitter 116, the printing material may be pushed into the nozzle 114 and expressed through the outlet opening 136. The material properties and features of the nozzle 114 may provide improved adhesion of the printing material dispensed from the nozzle 114 to underlying printed material, improve printing material flow through the nozzle 114, and may reduce and/or eliminate stringing relative to other nozzle designs, such as nozzles having a drastic change in passageway diameter (e.g., a shelf-like transition) near a printing material outlet.

The nozzle assemblies 1100, 1200, 1300, shown in FIGS. 11-13, may operate similarly to the nozzle assembly 100, with the printing material flowing through multiple material splitters 1216, 1116 in the nozzle assembly 1200.

To evaluate performance, a 3-D printer was operated to conduct volumetric flow tests with and without a material splitter that was similar in construction to the material splitter 216 shown in FIGS. 4A-4D. The volumetric flow tests were performed with polyethylene terephthalate glycol (PETG) filament, at a temperature setting of 245° C., and a nozzle with a 0.4 mm opening.

The maximum operational flow rate (e.g., the maximum flowrate achieved prior to failure) without the material splitter was 23 cubic millimeters per second (23 mm³/sec). The maximum operational flow rate with the material splitter was 30 mm³/sec. Accordingly, an increase of at least about 30% in the operational flow rate was achieved. It is expected that additional embodiments of the present disclosure may achieve even higher relative flowrates.

While various aspects and embodiments have been disclosed herein, other aspects and embodiments are contemplated. The various aspects and embodiments disclosed herein are for purposes of illustration and are not intended to be limiting.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall have the same meaning as the word “comprising” and variants thereof (e.g., “comprise” and “comprises”).

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, ±2%, ±1%, or ±0% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

1. A material splitter comprising:
an annular portion having an outer surface sized and configured for insertion into and to abut of an inner wall of a bore of a nozzle body of a three-dimensional printer;
a central portion located at least partially within the annular portion;
a plurality of ribs extending laterally between and connecting the annular portion to the central portion; and
a plurality of passageways extending through the material splitter defined by the annular portion, the central portion, and the plurality of ribs;
wherein the material splitter is a monolithic superhard material.

2. The material splitter of claim 1, further comprising a spike extending longitudinally from an upper end of the central portion, the spike having a pointed end.

3. The material splitter of claim 1, wherein the material splitter is a monolithic diamond structure.

4. The material splitter of claim 2, wherein the material splitter has laser-ablated surfaces.

5. The material splitter of claim 1, wherein each of the plurality of passageways has an elongated arcuate cross-sectional shape with rounded ends.

6. The material splitter of claim 5, wherein each of the plurality of passageways have an inlet opening that is larger than an outlet opening.

7. The material splitter of claim 6, wherein each of the plurality of passageways has a continuous taper from the inlet opening to the outlet opening.

8. The material splitter of claim 5, further comprising a radiused edge at an inlet opening of each of the plurality of passageways.

9. The material splitter of claim 8, further comprising a radiused edge at an outlet opening of each of the plurality of passageways.

10. The material splitter of claim 1, wherein the material splitter is configured to increase the maximum operational flow rate of a three-dimensional printer by at least about 30%.

11. A nozzle assembly comprising:
a base configured to be part of a three-dimensional printer, the base defining a recess; and
a material splitter positioned within the recess, the material splitter comprising:
an annular portion having an outer surface sized to abut a bore of the recess;
a central portion located at least partially within the annular portion;
a plurality of ribs extending laterally between and connecting the annular portion to the central portion; and
a plurality of passageways extending through the material splitter defined by the annular portion, the central portion, and at least one rib of the plurality of ribs;
wherein the material splitter is a monolithic diamond structure.

12. The nozzle assembly of claim 11, further comprising a hollow sleeve press-fit into the recess and securing the material splitter within the recess.

13. The nozzle assembly of claim 12, further comprising a nozzle positioned within the recess, the hollow sleeve securing the material splitter and the nozzle within the recess.

14. The nozzle assembly of claim 12, wherein the hollow sleeve is a monolithic diamond structure.

15. The nozzle assembly of claim 11, further comprising at least a second material splitter positioned within the recess adjacent to the material splitter.

16. The nozzle assembly of claim 11, further comprising a nozzle, wherein the material splitter is secured within the recess by the nozzle.

17. The nozzle assembly of claim 11, further comprising a nozzle having a passageway extending through the nozzle with a material inlet and a material outlet, the passageway including a constriction between the material inlet and the material outlet, the constriction having a diameter smaller than the material inlet and the material outlet, and wherein surfaces defining the passageway are oriented at an angle that is less than about 45 degrees relative to a longitudinal axis of the nozzle.

18. The nozzle assembly of claim 17, wherein the nozzle further comprises a substantially planar surface at a tip surrounding the material outlet of the bore, the substantially planar surface having a diameter that is at least about 2 times the diameter of the material outlet of the bore.

19. A method of manufacturing a material splitter for a nozzle assembly for three-dimensional printing, the method comprising:
forming a precursor structure comprising a superhard material; and
removing a portion of the superhard material from the precursor structure to form a material splitter from the superhard material.

20. The method of claim 19, wherein removing the portion of the superhard material from the precursor structure comprises laser ablation of the portion of the superhard material.
